(19) United States
(12) Patent Application Publication
(10) Pub. No.: US 2013/0275428 A1
(43) Pub. Date: Oct. 17, 2013

(54) NAVIGATION DEVICE

(71) Applicants: Takeo Sakairi, Tokyo (JP); Takashi Tamada, Tokyo (JP); Mitsuo Shimotani, Tokyo (JP); Makoto Mikuriya, Tokyo (JP)

(72) Inventors: Takeo Sakairi, Tokyo (JP); Takashi Tamada, Tokyo (JP); Mitsuo Shimotani, Tokyo (JP); Makoto Mikuriya, Tokyo (JP)

(73) Assignee: MITSUBISHI ELECTRIC CORPORATION, Tokyo (JP)

(21) Appl. No.: 13/993,998

(22) PCT Filed: Mar. 29, 2011
(86) PCT No.: PCT/JP2011/001870

§ 371 Date: Jun. 13, 2013

(51) Int. Cl. G01C 21/00; G06F 17/30

(52) U.S. Cl. CPC G01C 21/00; G06F 17/30595
USPC 707/736

(57) ABSTRACT

Disclosed is a navigation device including a navigation function performing unit 13b for performing navigation processing, a data relation information storage unit 5a for storing data relation information in which data related each other which construct map data in a map DB is defined for each function carried out by the navigation function performing unit as the navigation processing, the data relation information being generated by an external map generating device 15 on the basis of a data relation definition defining a relation between data which construct map data in the map DB, and a data access unit 14a for referring to the data relation information stored in the data relation information storage unit 5a to acquire map data for use in the navigation function performing unit 13b when performing the navigation processing from the map DB.

### FIELD OF THE INVENTION

The present invention relates to a navigation device that acquires desired data from a database on the basis of data relation information defining a relation between data required to execute an application for implementing each of various functions of navigation processing to carry out the navigation processing.

### BACKGROUND OF THE INVENTION

For example, a route guidance device disclosed by patent reference 1 assigns an identifier to a road to which each road link which constructs a road network of a map database belongs, and, when generating guidance data about a route expressed by the series of identifiers of road links from the route and the current position of a vehicle, refers to a correspondence list in which a correspondence between road attributes each showing a road name and a road type, and the identifier of each road link is defined to acquire information including the road names of the roads to which the road link expressing the route along which the route guidance device guides the driver of the vehicle belong.

### RELATED ART DOCUMENT

### Patent Reference

Patent reference 1: Japanese Unexamined Patent Application Publication No. JP-A 11-351869

### SUMMARY OF THE INVENTION

### Problems to be Solved by the Invention

A conventional technology represented by patent reference 1 is based on the premise that a correspondence list for defining a relation between specific data, such as the identifiers of road links and road attributes, in a map database is generated in advance, and a correspondence list regarding data other than those data is not taken into consideration. A problem is therefore that in order to acquire data required to execute a function other than route guidance from the map database or the like, it is necessary to access data while analyzing a relation between data which construct the data in the database, and therefore efficient and high-speed data access cannot be carried out.

The present invention is made in order to solve the above-mentioned problem, and it is therefore an object of the present invention to provide a navigation device that can acquire map data from a map database by referring to data relation information defining a relation between data which construct the map data in the map database to carry out navigation processing.

### Means for Solving the Problem

In accordance with the present invention, there is provided a navigation device that carries out navigation processing by using data which the navigation device acquires from a data set, the navigation device including: a storage unit for storing data relation information in which data related each other in the data set is defined, the data relation information being generated by an external device on the basis of a data relation definition defining a relation between data in the data set; a navigation function performing unit for performing the navigation processing; and a data access unit for referring to the data relation information stored in the storage unit to acquire data for use in the navigation function performing unit when performing the navigation processing from the data set.

### Advantages of the Invention

According to the present invention, there is provided an advantage of being able to refer to data relation information in which data related to each other in a data set, such as a map database, are set to efficiently acquire desired data from the data set at a high speed and carry out the navigation processing.

### BRIEF DESCRIPTION OF THE FIGURES

FIG. 1 is a block diagram showing the structure of a relation information generating device in accordance with Embodiment 1 of the present invention;

FIG. 2 is a block diagram showing an example of the hardware configuration of an information processing device to which the present invention is applied;

FIG. 3 is a flow chart showing an outline of a generating process of generating data relation information in the relation information generating device in accordance with Embodiment 1;

FIG. 4 is a diagram showing an example of a relation between data in a relational database;

FIG. 5 is a diagram showing the order of establishing relations among data shown in FIG. 4 using a hierarchical structure;

FIG. 6 is a diagram showing an example of the data format of a data relation definition;

FIG. 7 is a diagram showing a case in which the data format of the data relation definition shown in FIG. 6 is expressed in an XML form;

FIG. 8 is a diagram showing examples of the data relation definition shown in FIG. 6;

FIG. 9 is a diagram showing a case in which data relation definitions shown in FIG. 6 are expressed in an XML form;

FIG. 10 is a diagram showing an example of a relation between variable length data in a relational database;

FIG. 11 is a diagram showing an example of the data format of a data relation definition in a case in which data in a relation destination are variable in length;

FIG. 12 is a diagram showing an example of the data relation definition shown in FIG. 11;

FIG. 13 is a diagram showing an example of the data format of a data relation definition in a case of using data in a relation source;

FIG. 14 is a diagram showing a case in which the data relation definition shown in FIG. 13 is expressed in an XML form;

FIG. 15 is a diagram showing an example of the data format of a data relation definition in a case in which data in a relation source and data in a relation destination are variable in length;

FIG. 16 is a diagram showing a case in which the data relation definition shown in FIG. 15 is expressed in an XML form;

FIG. 17 is a diagram showing an example in a case in which a relation between data is established via variable length common keys;

FIG. 18 is a diagram showing an example of the format of a data relation definition in a case in which common keys are variable in length;

FIG. 19 is a diagram showing an example of the data relation definition shown in FIG. 18;

FIG. 20 is a diagram showing an example of the data format of data relation information;

FIG. 21 is a diagram explaining a procedure for generating data relation information;

FIG. 22 is a diagram showing an example of the data format of data relation information and a data relation information definition;

FIG. 23 is a diagram showing an example of a data relation information definition in a case in which data in a relation destination are variable in length;

FIG. 24 is a diagram showing data relation information in which actual data of data in a relation destination are stored;

FIG. 25 is a diagram showing data relation information in which an index of data in a relation destination is stored;

FIG. 26 is a diagram showing data relation information in which an offset of data in a relation destination is stored;

FIG. 27 is a diagram showing an outline of a usage pattern of data relation information generated for each of functions which are implemented by various applications;

FIG. 28 is a diagram showing an example of data definition information;

FIG. 29 is a block diagram showing another example of the structure of the relation information generating device in accordance with Embodiment 1;

FIG. 30 is a flow chart showing the details of the generating process of generating data relation information in the relation information generating device in accordance with Embodiment 1;

FIG. 31 is a diagram showing a case in which a data relation information output definition is expressed in an XML form;

FIG. 32 is a block diagram showing the structure of a map generating device in accordance with Embodiment 2 of the present invention;

FIG. 33 is a diagram showing the structure of a map database;

FIG. 34 is a diagram for explaining an outline of the generation of a map for use in route guidance;

FIG. 35 is a diagram showing relations among various data shown in FIG. 34;

FIG. 36 is a diagram showing an example of data relation definitions of map data;

FIG. 37 is a diagram showing an example of data relation information of map data;

FIG. 38 is a block diagram showing another example of the structure of the map generating device in accordance with Embodiment 2;

FIG. 39 is a block diagram showing the structure of a navigation device in accordance with Embodiment 3 of the present invention;

FIG. 40 is a flow chart showing a flow of an application process carried out by the navigation device in accordance with Embodiment 3;

FIG. 41 is a diagram showing an outline of a usage pattern of data relation information generated for each of functions which are implemented by various navigation applications;

FIG. 42 is a block diagram showing another example of the structure of the navigation device in accordance with Embodiment 3;

FIG. 43 is a diagram showing an outline of another usage pattern of the data relation information generated for each of the functions which are implemented by the various navigation applications;

FIG. 44 is a block diagram showing the structure of a navigation device in accordance with Embodiment 4 of the present invention;

FIG. 45 is a block diagram showing another example of the structure of the navigation device in accordance with Embodiment 4;

FIG. 46 is a flow chart showing an example of a generating process of generating data relation information about an area surrounding the current position;

FIG. 47 is a flow chart showing an example of a generating process of generating data relation information about the user's own country;

FIG. 48 is a flow chart showing an updating process of updating data relation information; and

FIG. 49 is a flow chart showing an example of a generating process of generating data relation information which is caused by an update of a data relation definition.

### EMBODIMENTS OF THE INVENTION

Hereafter, in order to explain this invention in greater detail, the preferred embodiments of the present invention will be described with reference to the accompanying drawings.

### Embodiment 1

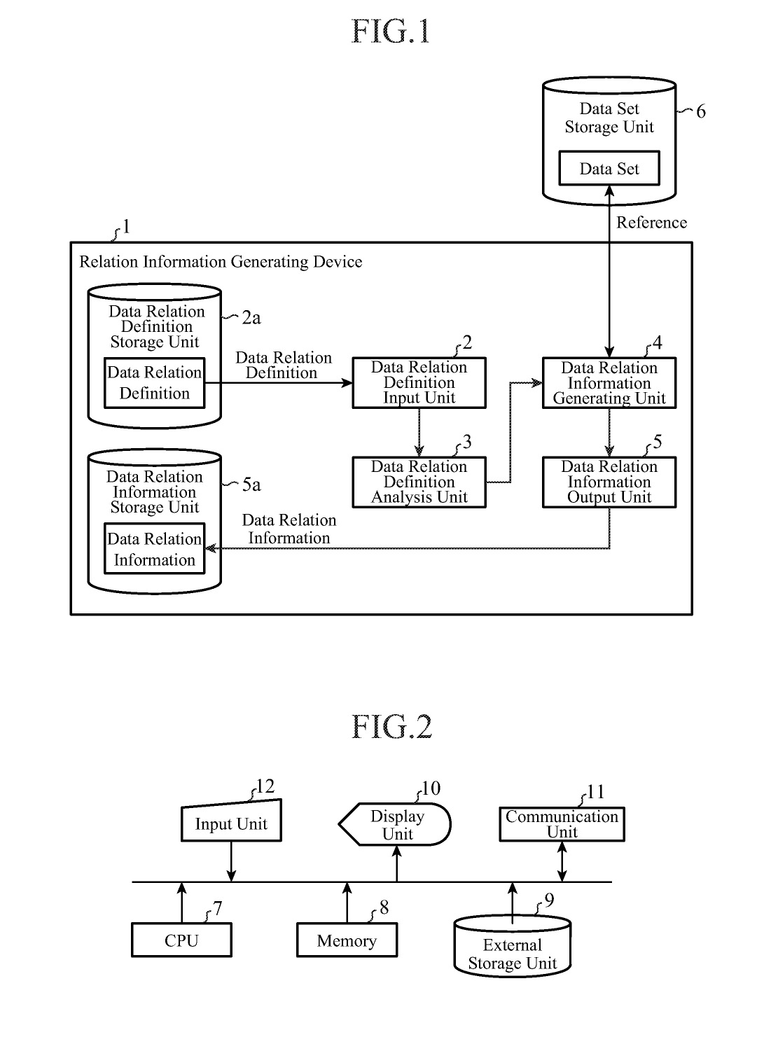

FIG. 1 is a block diagram showing the structure of a relation information generating device in accordance with Embodiment 1 of the present invention. In FIG. 1, the relation information generating device 1 in accordance with Embodiment 1 automatically generates data relation information on the basis of a data relation definition. A data relation definition is data defining a relation between data in a data set (database or file system) in which actual data that are decentralized-managed are stored while being brought into correspondence with each other in a relational form. Further, data relation information is the one in which data related to each other in the above-mentioned data set are set. For example, by referring to data relation information about a plurality of data (a road name, an intersection name, a road geometry, a guiding voice, a crossing image, etc.) which are used for route guidance in navigation processing, these data can be recognized as data related to each other which construct map data in a map database, and can be acquired from the map database one after another.

Further, the relation information generating device 1 is provided with a data relation definition input unit 2, a data relation definition storage unit 2a, a data relation definition analysis unit 3, a data relation information generating unit 4, a data relation information output unit 5, and a data relation information storage unit 5a, as shown in FIG. 1. The data relation definition input unit 2 is a component for inputting a data relation definition from the data relation definition storage unit 2a into the data relation definition analysis unit. For example, the data relation definition input unit retrieves a data relation definition specified by a not-shown external device from the data relation definition storage unit 2a. Data related definitions regarding a data set stored in a data set storage unit 6 are stored in the data relation definition storage unit 2a. The data relation definition analysis unit 3 is a component for analyzing the descriptions of a data relation definition, i.e., a relation between data which is defined in a data relation definition.

The data relation information generating unit 4 is a component for generating data relation information defining a relation between data in the data set stored in the data set storage unit 6 in an output form defined by a data relation information output definition on the basis of the results of the analysis of a data relation definition by the data relation definition analysis unit 3. The data relation information output unit 5 is a component for storing the data relation information generated by the data relation information generating unit 4 in an output destination of a storing method defined in the data relation information output definition. The data relation information storage unit 5a stores the data relation information generated by the data relation information generating unit 4.

FIG. 2 is a block diagram showing an example of the hardware configuration of an information processing device to which the present invention is applied. In the example shown in FIG. 2, a car navigation device or a moving object information terminal, such as a mobile phone or a PDA (Personal Digital Assistant), can be provided as this information processing device, for example. In an external storage unit 9 shown in FIG. 2, data which are used by a program for generation of relation information, a data access program, an application program, and an application process, etc. are stored.

The program for generation of relation information, and the data access program and the application program are expanded from the external storage unit 9 onto a memory 8, and are executed by a CPU 7. In this example, a program module for implementing the function of each component of the relation information generating device 1 is described in the program for generation of relation information. The above-mentioned information processing device functions as the relation information generating device 1 by making the CPU 7 execute this program for generation of relation information.

The application program implements various functions carried out by the above-mentioned information processing device. For example, the application program implements a route guidance function, a map display function, and a route search function in a car navigation device. The data access program acquires data required to execute the application program from the data set stored in the external storage unit 9. For example, the data required to execute the application program include data relation definitions, data relation information, and a data set which are shown in FIG. 1. More specifically, the external storage unit 9 functions as the data relation definition storage unit 2a, the data relation information storage unit 5a, and the data set storage unit 6. The external storage unit 9 can be constructed in a hard disk drive unit (HDD) mounted in the above-mentioned information processing device, an external storage medium, such as a CD or DVD, which can be played back by a drive device, a USB (Universal Serial Bus) memory from and into which data are read and written via a predetermined input/output interface, or the like.

The computation results acquired by the CPU 7 are outputted to a display unit 10 via a bus, and are displayed on the screen of the display unit. The display unit 10 displays information such as a map for use in route guidance, and is implemented by a liquid crystal display, a plasma display, or the like. A communication unit 11 communicates with a not-shown external device. When the above-mentioned information processing device is a car navigation device, the communication unit 11 also functions as a position detecting unit for receiving GPS signals from GPS (Global Positioning System) satellites or an FM radio signal to detect position information. An input unit 12 accepts an operational input from outside the information processing device, and corresponds to a keyboard, operation switches, a touch panel combined with the display unit 10, or the like. When the above-mentioned information processing device is a car navigation device, the information processing device receives conditions for a route search, and so on by using this input unit 12.

In the above-mentioned explanation, although the case in which the data for use in the program for generation of relation information, the data access program, the application program, and the application process are stored in the external storage unit 9 is shown, this case is only an example. More specifically, each of the above-mentioned programs or at least one of these programs can be stored in another storage unit from which the CPU 7 can read data.

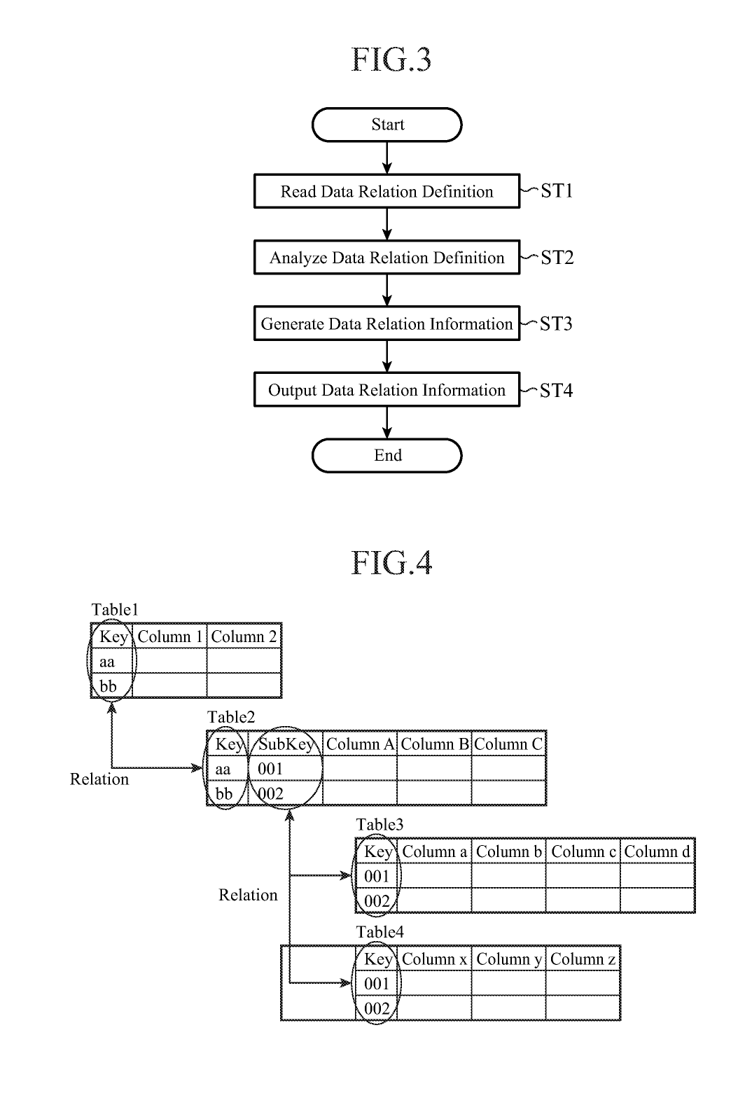

Next, the operation of the information processing device will be explained. FIG. 3 is a flow chart showing an outline of the generating process of generating data relation information in Embodiment 1. First, the data relation definition input unit 2 inputs a data relation definition regarding data which is specified by a not-shown external device (e.g., a map generating device which will be mentioned below in Embodiment 2) from the data relation definition storage unit 2a into the data relation definition analysis unit (step ST1). Next, the data relation definition analysis unit 3 analyzes a relation between data which is defined in the data relation definition acquired by the data relation definition input unit 2 (step ST2). The data relation information generating unit 4 then generates data relation information in an output form defined in a data relation information output definition on the basis of the relation between data which is determined from the results of the analysis of a data relation definition by the data relation definition analysis unit 3 (step ST3). Next, the data relation information output unit 5 stores the data relation information generated by the data relation information generating unit 4 in the output destination of a storing method defined in the data relation information output definition (step ST4). For example, the data relation information output unit incorporates the data relation information in a data set to which the data relation information generating unit has referred when generating the data relation information, or outputs the data relation information to another data set disposed separately from this data set.

### (1) With Regard to Database

Next, a data set (database) which is handled in the present invention will be explained. In the present invention, a relational database (referred to as an RDB from here on) or file system in which data are related to each other by using a structure called relation is set as a target for data access. FIG. 4 is a diagram showing an example of a relation between data in an RDB. As shown in FIG. 4, in the RDB, actual data are managed in each table, and data are stored in each column in each table. Further, tables are related to each other via common keys. For example, Table1 (table data having a table name of “Table1”) and Table2 (table data having a table name of “Table2”) are related to each other via common keys which are “aa” and “bb” in their Key columns. Further, in Table2 and Table3 (table data having a table name of “Table3”), the data in a SubKey column of Table2 are “001” and “002” and the data in a Key column of Table3 are “001” and “002” which are the same as those in the SubKey column of Table2, and Table2 and Table3 are related to each other via those data. Similarly, in Table2 and Table4 (table data having a table name of “Table4”), the data in the SubKey column of Table2 are “001” and “002” and the data in a Key column of Table4 are “001” and “002” which are the same as those in the SubKey column of Table2, and Table2 and Table4 are related to each other via those data.

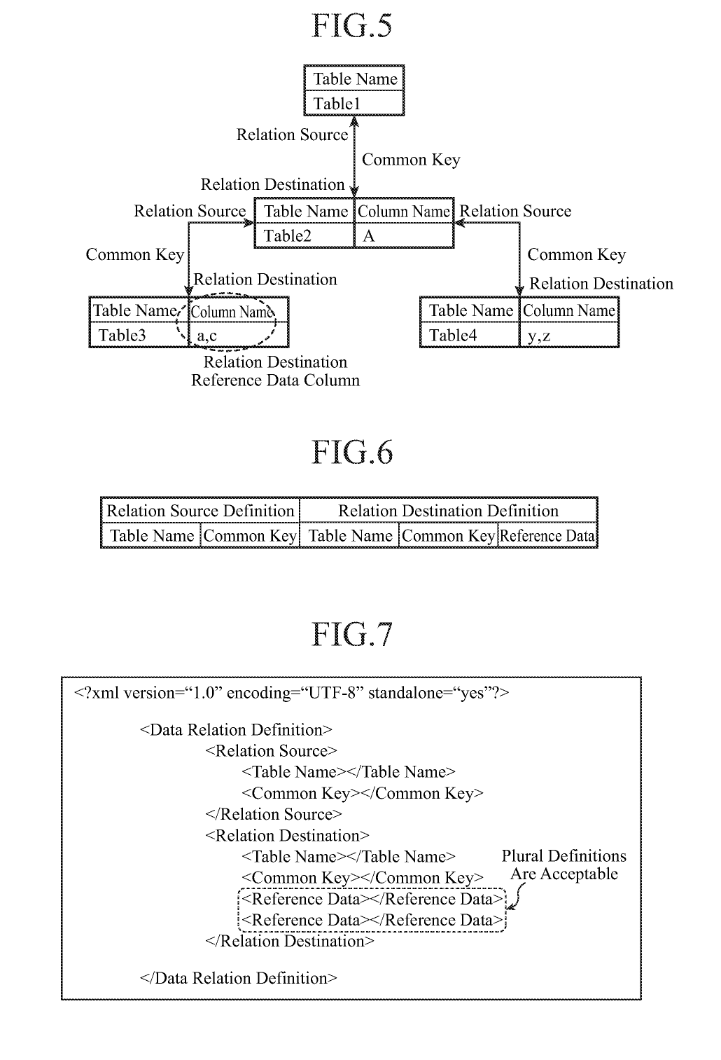

FIG. 5 is a view showing the order of relating the data shown in FIG. 4 to each other by using a hierarchical structure. In the example of FIG. 5, Table1 which is a relation source is related to the data in a column A of Table2 (column having a column name of “A”) as a relation destination. In addition, the data in the column A of Table2, which are provided as a relation source, are related to the data in columns a and c of Table3 (columns whose column names are “a” and “c”) and to the data in columns y and z of Table4 (columns whose column names are “y” and “z”) via common keys. By thus setting up common keys between tables in the RDB, data in tables can be related to each other. For example, when the data for use in route guidance are stored in the column A of Table2, the columns a and c of Table3, and the columns y and z of Table4, respectively, the information processing device can grasp a relation between desired data in the data set by referring to the common keys which the navigation device has acquired by analyzing data relation information when accessing to data in the data set, and acquire the desired data from the data set efficiently at a high speed.

### (2) With Regard to Data Relation Definition

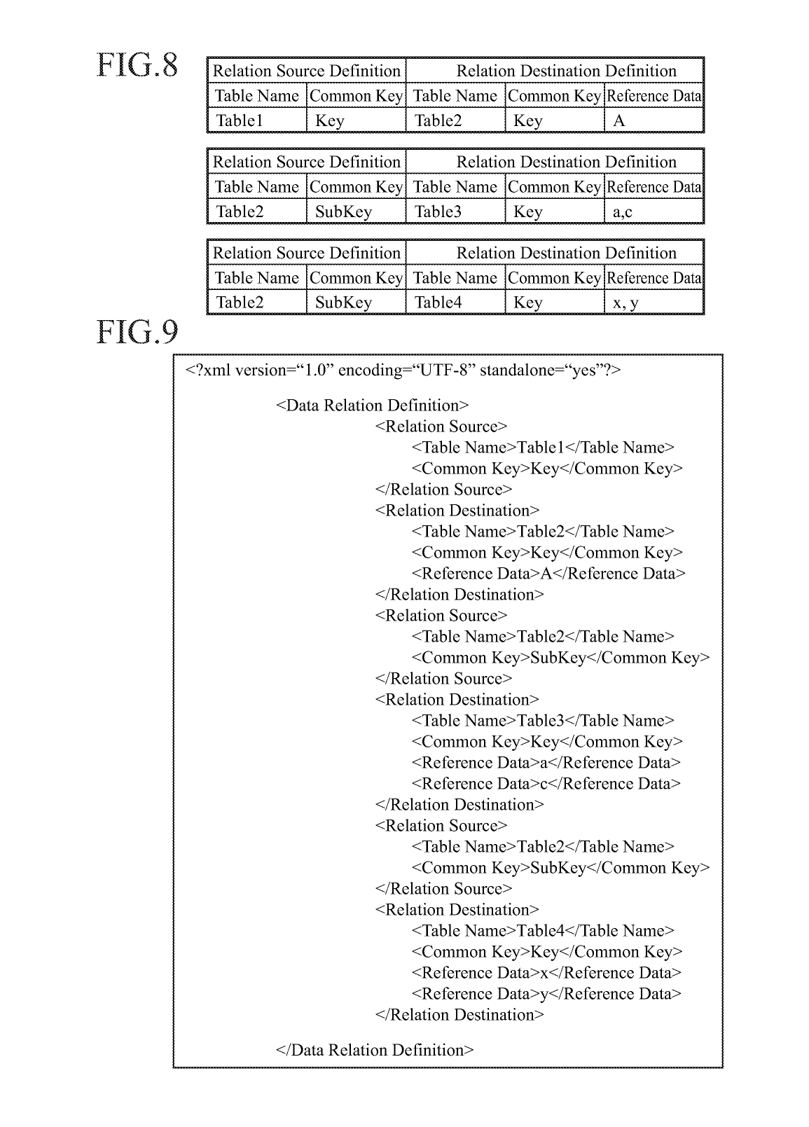

Next, the details of a data relation definition of such a database constructed as above will be described. FIG. 6 is a diagram showing an example of the data format of a data relation definition, and shows the data format in a table form. A data relation definition includes one data that are defined as data in the relation source and other data that are defined as data in the relation destination, the data and the other data being aligned according to the order of establishing a relation between them. In the data format of a data relation definition, as shown in FIG. 6, item fields in which a table name showing a table in which relation source data are stored, and a common key for specifying a relation between the relation source and the relation destination are set are disposed as a relation source definition, and item fields in which a table name showing the table in which relation destination data are stored, a common key, and reference data which are the relation destination data are set as disposed as a relation destination definition. Further, actual data of the reference data in the relation destination, an index used for retrieving the reference data from the database, and an offset showing the storing position of the reference data in the database are set to the reference data column of the relation destination definition. FIG. 7 is a diagram showing a case in which the data format of the data relation definition shown in FIG. 6 is expressed in an XML (eXtensible Markup Language) form. The contents of the reference data column in a data relation definition in a tabular form correspond to a portion shown by a reference data tag in a data relation definition in an XML form. As shown in FIG. 7, a plurality of data which are registered in the relation destination can be set to the reference data tag. FIG. 8 is a diagram showing an example of such a data relation definition as shown in FIG. 6, and shows a case in which a relation among the data shown in FIG. 5 is defined. As shown in FIG. 8, in each data relation definition, a table name and a common key are set as the relation source data, and a table name, a common key, and reference data are set as the relation destination data. FIG. 9 is a diagram showing a case where the data relation definitions shown in FIG. 8 are expressed in an XML form. As shown in FIG. 9, each data relation definition defining a relation between data in the relation source and data in the relation destination is provided as data combined sequentially according to the order of establishing the relation between them because the data relation definition is expressed in an XML form.

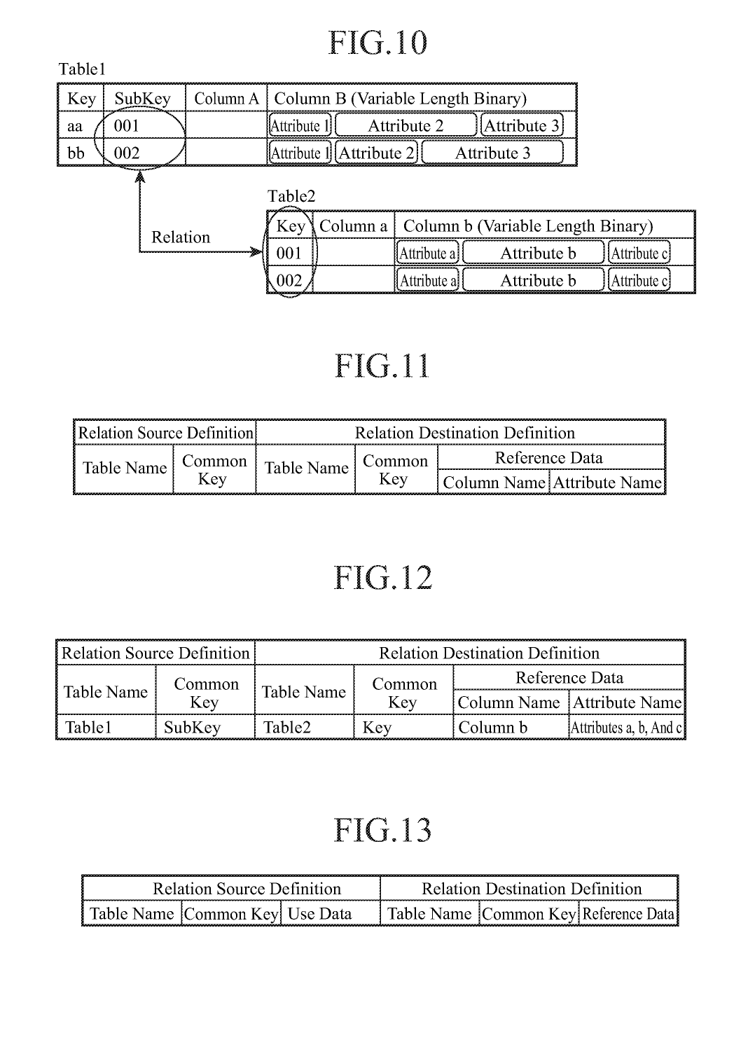

FIG. 10 is a diagram showing an example of a relation between variable length data in an RDB. In the example shown in FIG. 10, among the data in Table1 and Table2, the data in a SubKey column of Table1 are “001” and “002” and the data in a Key column of Table2 are “001” and “002” which are the same as those in the SubKey column of Table1, and Table1 and Table2 are related to each other via those data. Further, variable length binary data which consist of attribute 1, attribute 2, and attribute 3 are stored in a column B of Table1. Variable length binary data which consist of attribute a, attribute b, and attribute c are stored in a column b of Table2. FIG. 11 is a diagram showing an example of the data format of a data relation definition in which the data in the relation destination are variable in its length, and the data format is expressed in a tabular form. As shown in FIG. 11, when the reference data in the relation destination are variable length data, the column name of a column in which the variable length data are stored is set to the column of “column name”, and the attribute name of an attribute of the variable length data is set to the column of “attribute name.” Further, FIG. 12 is a diagram showing an example of the data relation definition shown in FIG. 11, and shows the establishment of the relation shown in FIG. 10. As shown in FIG. 12, the reference data in Table2 which is a relation destination has a column name of column b, and define attributes a, b, and c to be used by using commas as delimiters.

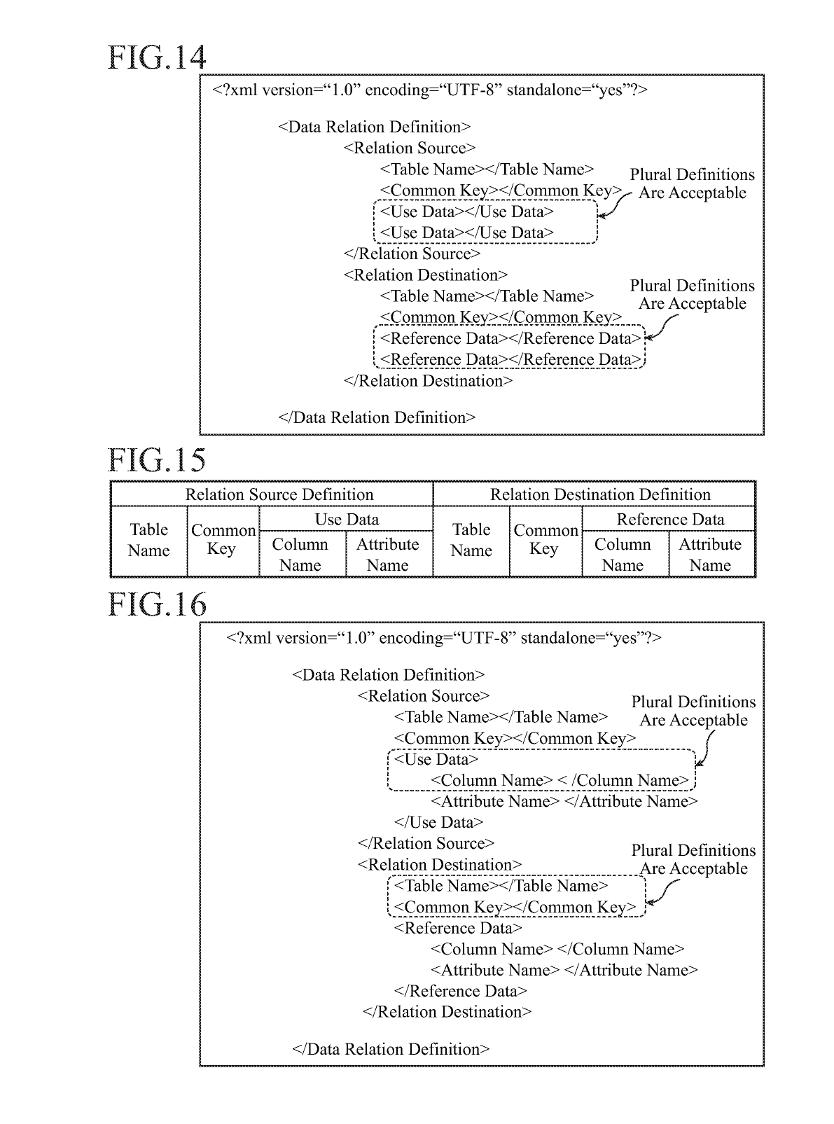

FIG. 13 is a diagram showing an example of the data format of a data relation definition in which the data in the relation source are used, and is expressed in a tabular form. It is assumed that data related to other data use not only the data in the relation destination but also the data in the relation source. In this case, a relation between data is defined in a data format which can be set also for data in the relation source. For example, when data used for data relation information in the relation source (referred to as use data from here on) is fixed length data, a use data column for storing the use data in the relation source is disposed in the relation source definition, as shown in FIG. 13. The column name of the use data in the relation source is defined in the use data column. FIG. 14 is a diagram showing a case in which the data relation definition shown in FIG. 13 is expressed in an XML form. The contents of the use data column in a data relation definition in a tabular form correspond to a portion shown by a use data tag in a data relation definition in an XML form. In this use data tag, a plurality of data registered in the relation source can be set, as shown in FIG. 14.

FIG. 15 is a diagram showing an example of the data format of a data relation definition in a case in which the data in the relation source and the data in the relation destination are variable in length, and expresses the data format in a tabular form. When both the data in the relation source and the data in the relation destination are variable in length, setting fields of “column name” and “attribute name” are disposed both in the use data column of the relation source definition and in the reference data column of the relation destination definition. The column name of a column in which the variable length data are stored is set to the column of “column name”, and the attribute name of an attribute of this variable length data is set to the column of “attribute name.” FIG. 16 is a diagram showing a case in which the data relation definition shown in FIG. 15 is expressed in an XML form. In FIG. 16, an item of the column name of the use data column in the data relation definition in a tabular form corresponds to a portion shown by a column name tag of the data relation information in an XML form, and an item of the table name and an item of the common key in the relation destination definition of the data relation definition in a tabular form correspond to a portion shown by a table name tag and a portion shown by a common key tag of the relation destination definition in the data relation information in an XML form, respectively. Also as the data shown by these tags, a plurality of data registered in each of the source and relation destinations can be set, as shown in FIG. 16.

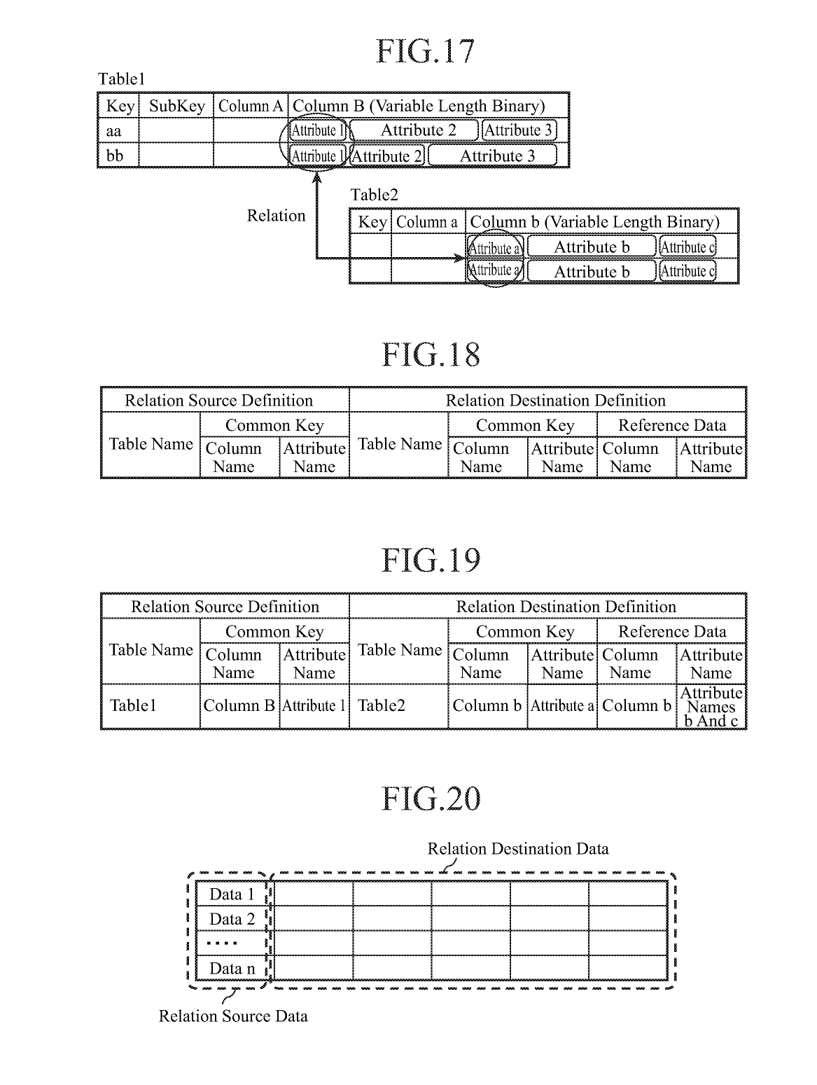

FIG. 17 is a diagram showing an example in which a relation between data is established via variable length common keys. In the example of FIG. 17, the common keys of Table1 which is a relation source and the common keys of Table2 which is a relation destination are stored in their respective variable length columns in a binary format. More specifically, portions which consist of attribute 1 of the column B in Table1 are the common keys while portions which consist of attribute a of the column b in Table2 are the common keys. FIG. 18 is a diagram showing an example of the format of a data relation definition in a case in which the common keys are variable in length, and shows a case in which the format is expressed in a tabular form. As shown in FIG. 18, when the common keys of the relation source and those of the relation destination are variable in length, items to which “column name” and “attribute name” are set are disposed in the common keys of both the relation source definition and the relation destination definition. Further, FIG. 19 is a diagram showing an example of the data relation definition shown in FIG. 18, and defines the establishment of the relation shown in FIG. 17. As shown in FIG. 19, column B and attribute 1 are set as the common keys of the relation source, and column b and attribute a are set as the common keys of the relation destination.

Data relation definitions as mentioned above are generated in a tabular form or in an XML form in advance for a database from which data are used in target information processing. For example, when the information processing device which is the target for the generation of data relation information is a navigation device, data relation definitions for use in a map database are generated in advance.

(3) With Regard to data Relation Information

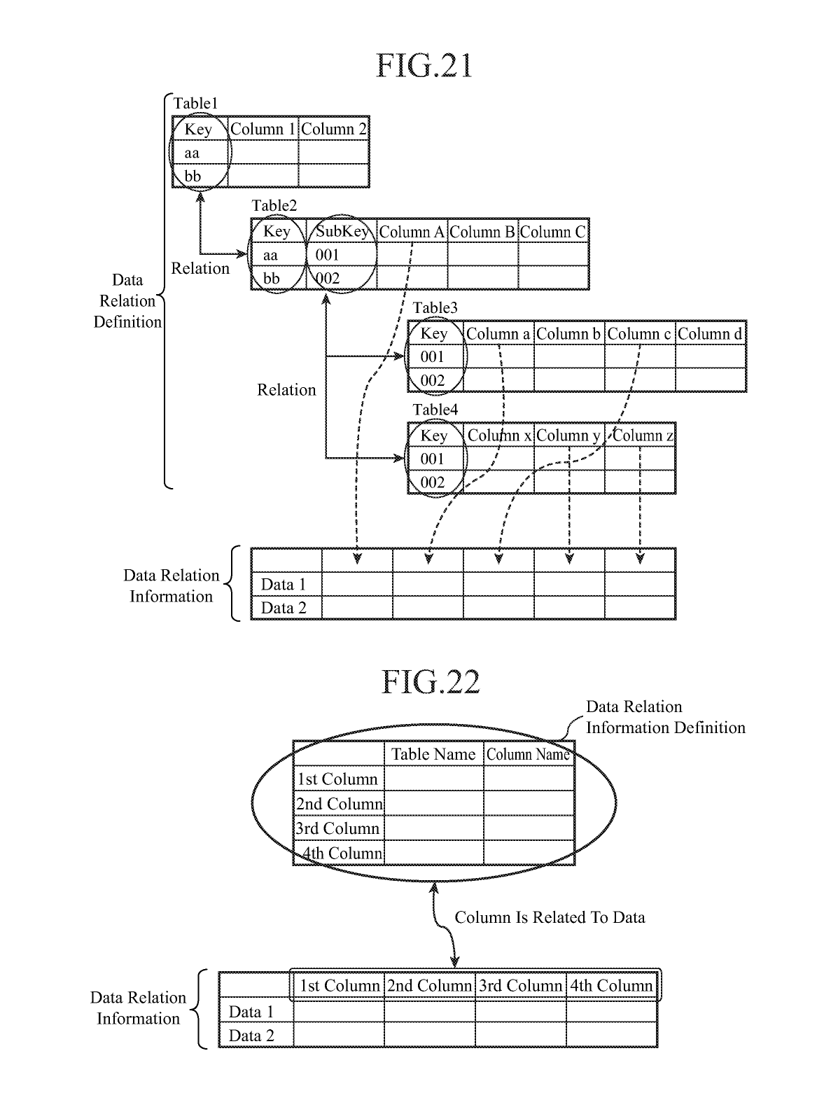

The data relation information generating unit 4 generates data relation information in an output form defined in a data relation information output definition on the basis of a relation between data which is specified from the results of the analysis of data relation definitions by the data relation definition analysis unit 3. FIG. 20 is a diagram showing an example of the data format of data relation information. As shown in FIG. 20, data (data 1, data 2, . . . , data n) in the relation source and data in the relation destination which correspond to the data in the relation source are set to the data relation information. FIG. 21 is a diagram explaining a procedure for generating data relation information, and shows data relation information generated by using the results of the analysis of the data relation definitions shown in FIG. 8. The data relation information generating unit 4 stores the data in the relation destinations in predetermined columns in turn according to the order of establishing the relations among the data which are specified by the data relation definition analysis unit 3 to generate data relation information, as shown in FIG. 21. In the example shown in FIG. 21, the data in the relation destinations are successively stored in adjacent columns of the data relation information in the order of the data in the column A of Table2 related to Table1, the data in the columns a and c of Table3 related to Table2, and the data in the columns y and z of Table4 related to Table2, as shown by dashed-line arrows. By thus storing the data in the relation destinations in the data relation information according to the order of establishing the relations among the data, the information processing device can easily grasp the order of establishing the relations among the data by simply analyzing the data relation information.

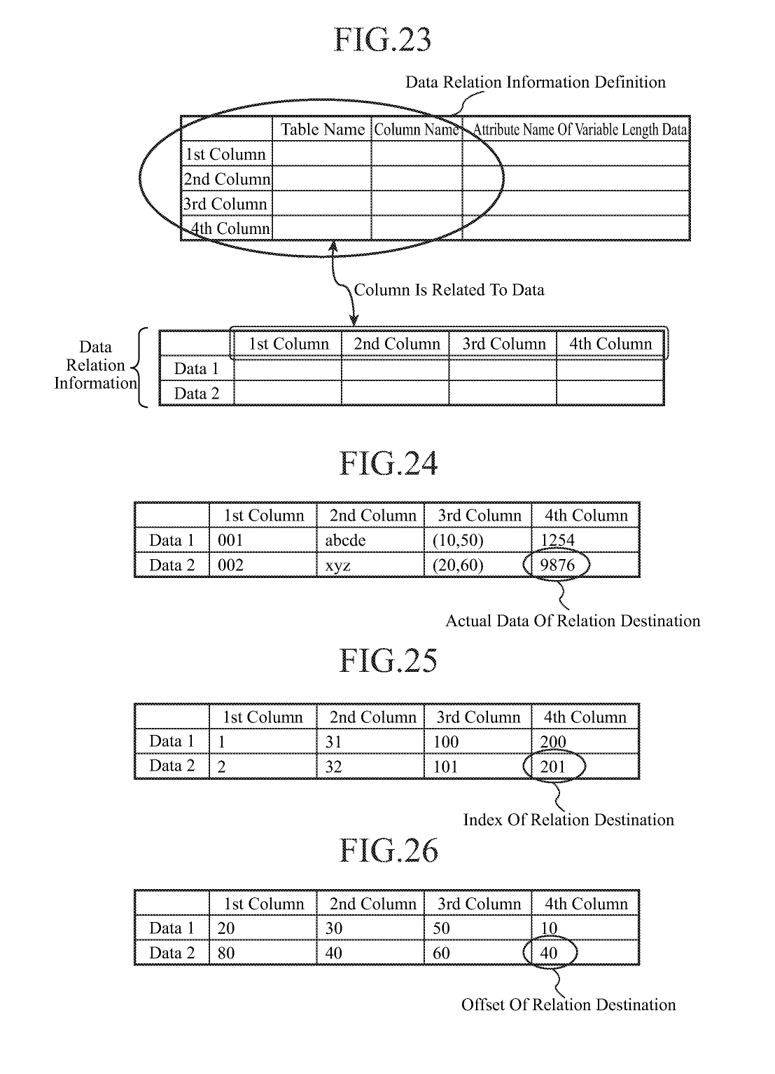

The order of storing the data in the relation destinations in the data relation information is not limited to the above-mentioned order of establishing the relations among the data. As an alternative, the data storage columns of the data relation information can be respectively brought into correspondence with the data in the relation destinations in advance. FIG. 22 is a diagram showing an example of the data format of the data relation information and data relation information definitions, and shows a case in which the data in the relation destinations are fixed in length. Each data relation information definition shown in FIG. 22 is information for defining the data in the relation destination which is be stored in each column (1st column, 2nd column, 3rd column, or 4th column shown in FIG. 22) in the data relation information. The data relation information generating unit 4 stores the relation destination data in the columns in turn on the basis of the correspondence between the columns and the data which is defined in the data relation information definitions to generate data relation information. When the relation destination data are variable in length, an attribute name showing the attribute of the variable length data, in addition to the table name and the column name for specifying the relation destination data, is set to each data relation information definition, as shown in FIG. 23.

As shown in FIG. 24, the actual data of the relation destination data can be stored in the data relation information. As a result, the information processing device can acquire the actual data which are desired data from the data relation information without referring to the tables in the data set, thereby being able to provide an improvement in the data access capability. Further, as shown in FIG. 25, the information processing device can store an index indicating each relation destination data, i.e., an index for identifying each actual data in the relation destinations in the data set. By thus storing indexes, the information processing device can prevent an increase in the data size because the information processing device does not have to carry out redundant management of the actual data for both the data relation information and the map DB even though the access speed is low as compared with the case in which the actual data are stored. In addition, as shown in FIG. 26, an offset of each relation destination data can be stored in the data relation information. The offset of each relation destination data is a value showing either the head of the relation destination data in the data set or the distance from the head to a specific component (data item). Because the provision of the offset eliminates the necessity to carry out redundant management of the actual data for the data relation information and for the map DB, like in the case of the indexes, an increase in the data size can be prevented. Further, when the variable length binary data are deserialized, the information processing device can access any desired attribute value at a high speed.

### (4) Usage Pattern of Data Relation Information

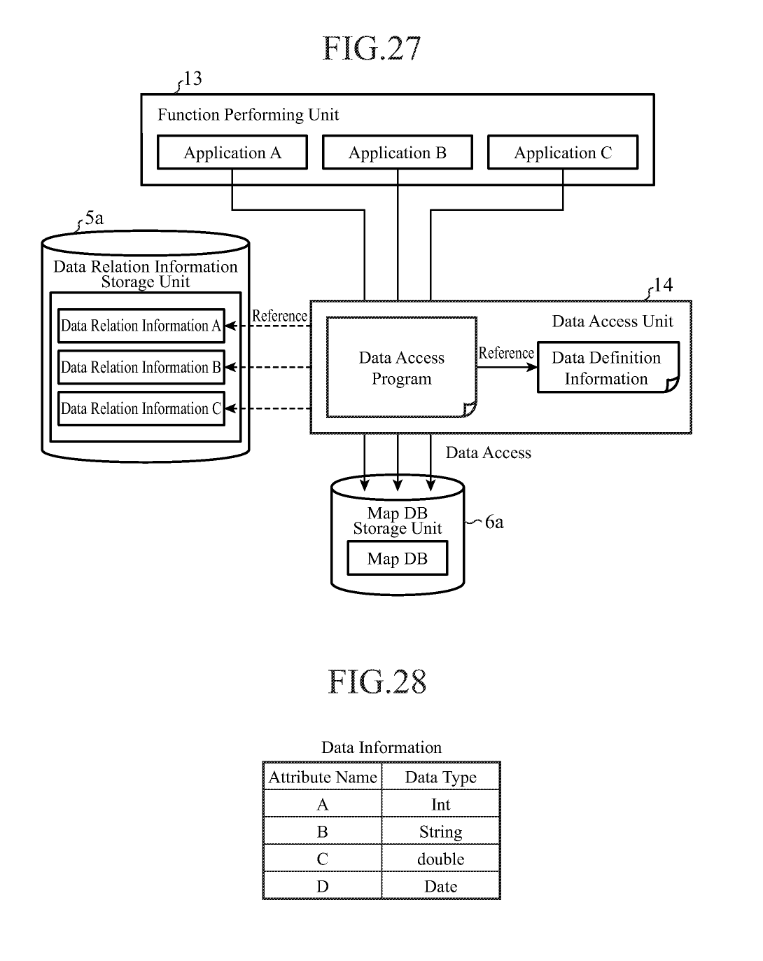

FIG. 27 is a diagram showing an outline of a usage pattern of the data relation information generated for each of the functions implemented by the various applications. The information processing device (information processing device shown in FIG. 2), such as a car navigation device, carries out the various functions (a route search, a map display, etc.) by using various application programs. The data relation information for each function which is generated by the relation information generating device 1 is registered in this information processing device. For example, as shown in FIG. 27, data relation information A corresponding to a function A, data relation information B corresponding to a function B, and data relation information C corresponding to a function C are stored in the data relation information storage unit 5a.

The CPU 7 of the information processing device operates as a function performing unit 13 that carries out a process corresponding to the function A by, for example, carrying out an application A regarding the function A. In this case, when there is a necessity to acquire the map data for use in the process corresponding to the function A from the map database (referred to as the map DB from here on) in the map DB storage unit 6a, the CPU 7 operates as the data access unit 14 by executing the data access program. At this time, because the data access unit 14 can grasp the map data related to each other which are used by the function A by referring to the data relation information A corresponding to the function A (application A), the information processing device can efficiently access any desired map data at a high speed to acquire the desired map data.

Further, in order to access data by referring to data relation information, the information processing device needs to grasp in what kind of form the data defined in the data relation information are stored. The definition of a data storage form in such data relation information is described in data definition information. FIG. 28 is a diagram showing an example of the data definition information. In the example shown in FIG. 28, an attribute name and a data type (integer value Int, floating point type float or double, string type String, date type Date, or the like) corresponding to each column of each table (FIGS. 24 to 26) in which data for which a relation is defined in data relation information is stored are included in the data definition information. For example, the data definition information is set to the data access program on a per data relation information basis. The data access unit 14 specifies the storage form of desired data (the storage form of desired data in the map DB) by referring to the data definition information, and accesses the data in the map DB.

### (5) With Regard to Data Relation Information Output Definition

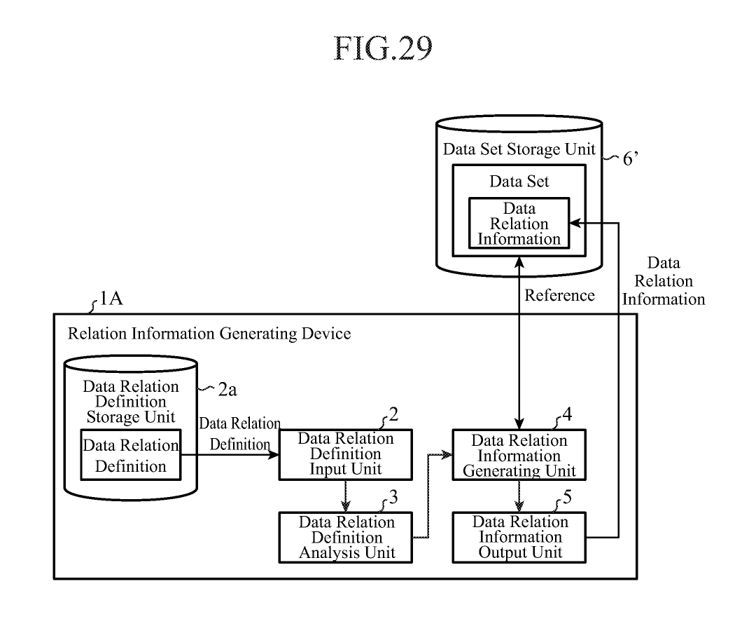

FIG. 29 is a block diagram showing another example of the structure of the relation information generating device in accordance with Embodiment 1. Referring to FIG. 29, the relation information generating device 1A incorporates the data relation information generated by the data relation information generating unit 4 into the data set stored in the data set storage unit 6′ to manage the data relation information. As mentioned above, the data relation information generating unit 4 generates data relation information in an output form defined in a data relation information output definition on the basis of a relation between data which is specified from the results of the analysis of data relation definitions by the data relation definition analysis unit 3. The data relation information output unit 5 further stores the data relation information generated by the data relation information generating unit 4 in the storage unit which is the output destination defined in the data relation information output definition. The relation information generating device 1A is equivalent to a structure when the storage unit which is the output destination defined in the data relation information output definition is the data set stored in the data set storage unit 6′.

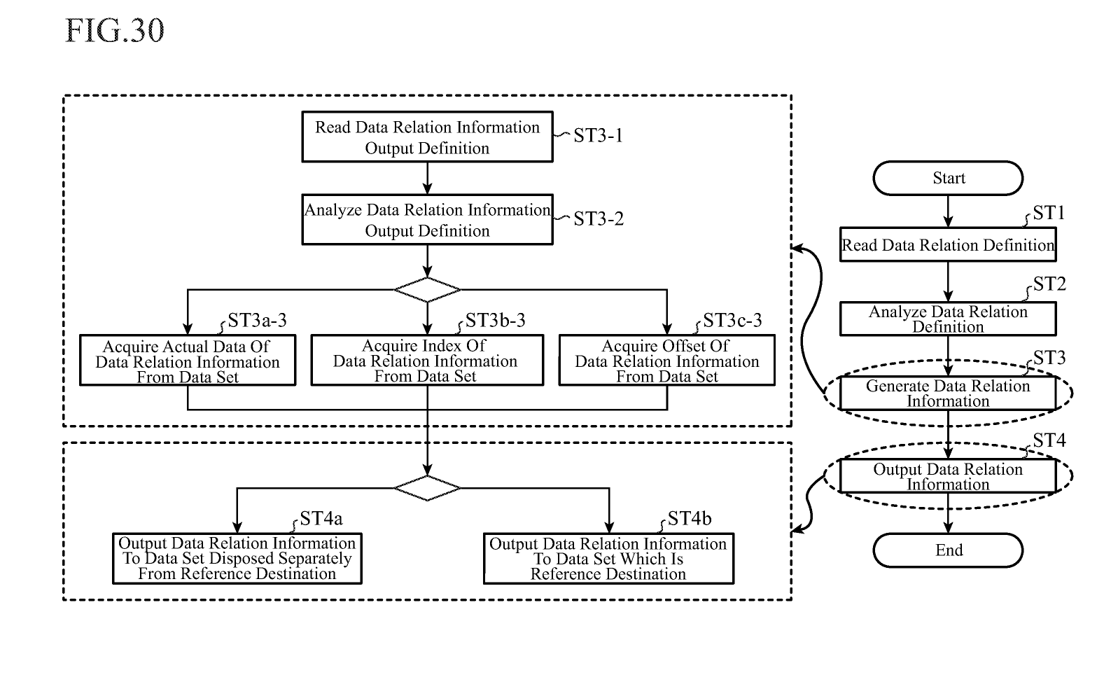

Hereafter, a process of referring to the data relation information output definition in the generating process of generating data relation information will be explained in detail. FIG. 30 is a flow chart showing the details of the generating process of generating data relation information in the information processing device in accordance with Embodiment 1. Steps ST3 and ST4, in the generating process of generating data relation information (flow chart corresponding to FIG. 3), which is described in a right portion of FIG. 30), correspond to the process of referring to the data relation information output definition. In the generating process of generating data relation information of step ST3, each process enclosed by a dashed line in a left portion of FIG. 30 and shown is carried out, and, in the output process of outputting the data relation information of step ST4, each process enclosed and shown by a dashed line in the left portion of FIG. 30 is carried out. First, when receiving the results of the analysis of data relation definitions by the data relation definition analysis unit 3, the data relation information generating unit 4 reads the data relation information output definition preset to the information processing device (step ST3-1).

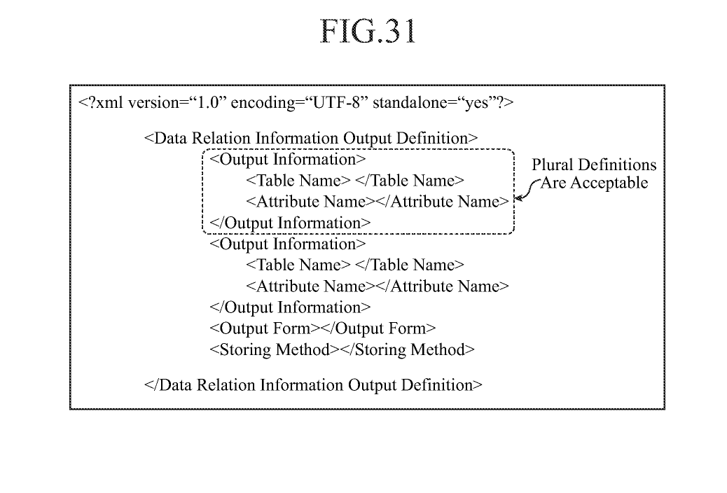

The data relation information generating unit 4 then analyzes the descriptions of the data relation information output definition read thereby to determine the output form of relation destination data and a storing method of storing the relation destination data (the output destination of the data relation information) (step ST3-2). FIG. 31 is a diagram showing a case in which the data relation information output definition is expressed in an XML form. In the data relation information output definition, output information about each data for which a relation is defined in a data relation definition is defined. In this case, the output information defines the output form and the storing method in the data relation information. As shown in FIG. 31, a plurality of data each of which defines output information can be set to a portion shown by an output information tag. Further, in order to specify data defining output information, a table name tag and an attribute name tag are disposed in an output form tag which is a child element of the output information tag. Table names respectively showing the relation destination and the relation source set to the data relation definition are defined in the table name tag, and a column name in which data in the relation destination or the relation source is stored (an attribute name when the data is variable-length one) is defined in the attribute name tag. In the data relation information output definition, output information is set for each data item which is outputted while being included in the data relation information. More specifically, whether the actual data in the relation destination or the relation source data is set to the data relation information, an index indicating the actual data in the relation destination or the relation source data is set to the data relation information, or an offset of the actual data in the relation destination or the relation source data is set to the data relation information is defined in a portion shown by the output form tag. For example, when a numerical value of “1” is defined in the output form tag, the data relation information generating unit 4 acquires the actual data by referring to the data set stored in either the data set storage unit 6 or the data set storage unit 6′, and generates data relation information (step ST3a-3). When a numerical value of “2” is defined in the output form tag, the data relation information generating unit 4 acquires an index indicating the actual data by referring to the data set stored in either the data set storage unit 6 or the data set storage unit 6′, and generates data relation information (step ST3b-3). When a numerical value of “3” is defined in the output form tag, the data relation information generating unit 4 acquires an offset of the actual data by referring to the data set stored in either the data set storage unit 6 or the data set storage unit 6′, and generates data relation information (step ST3c-3).

Further, the output destination of the generated data relation information is set to a portion shown by a storing method tag shown in FIG. 31, and only one output destination can defined for the data relation information. Whether the data relation information is stored in either another data set disposed separately from the data set which is referred to at the time of generating the data relation information in step ST3a-3, 3b-3, or 3c-3, or the data set used as the reference destination is set to the storing method tag. For example, when a numerical value of “1” is set to the storing method tag, the other data set disposed separately from the data set used as the reference destination is determined as the storage destination. In this case, the data relation information output unit 5 stores the data relation information generated by the data relation information generating unit 4 in the other data set disposed separately from the data set used as the reference destination, i.e., the data set stored in the data relation information storage unit 5a (step ST4a). This case corresponds to the structure of the relation information generating device 1 shown in FIG. 1. In contrast, when a numerical value of “2” is set to the storing method tag, the data set used as the reference destination is determined as the storage destination. In this case, the data relation information output unit 5 stores the data relation information generated by the data relation information generating unit 4 in the data set stored in the data set storage unit 6′ used as the reference destination (step ST4b). More specifically, this case corresponds to the structure of the relation information generating device 1A shown in FIG. 29.

As mentioned above, the information processing device in accordance with this Embodiment 1 includes: the data relation definition input unit 2 for inputting a data relation definition defining a relation between data in a data set into the data relation definition analysis unit; the data relation definition analysis unit 3 for analyzing the relation between the data defined in the data relation definition inputted thereto by the data relation definition input unit 2; and the data relation information generating unit 4 for generating data relation information in which data related to each other in the data set are set on the basis of the results of the analysis of the data relation definition by the data relation definition analysis unit 3. Because the information processing device is constructed in this way, the information processing device can generate data relation information in which desired data related to each other in the data set are set as needed.

Further, because the data relation information stores actual data of the data related to each other in the data set in the information processing device in accordance with this Embodiment 1, the information processing device can acquire the actual data of desired data from the data relation information without referring to tables in the data set, such as an RDB, thereby being able to provide an improvement in the data access capability.

In addition, because the data relation information can store an index for identifying the actual data of the data related to each other in the data set in the information processing device in accordance with this Embodiment 1, it is not necessary to carry out redundant management of the actual data for both the data relation information and the data set, and any increase in the data size can be prevented.

Further, because the data relation information can store a storage location in the data set of the actual data of the data related to each other in the data set in the information processing device in accordance with this Embodiment 1, it is not necessary to carry out redundant management of the actual data for both the data relation information and the data set, like in the case in which the data relation information stores an index, and any increase in the data size can be prevented. In addition, when variable length binary data are deserialized, the information processing device can access a desired attribute value at a high speed.

Further, because the information processing device in accordance with this Embodiment 1 includes the data relation information output unit 5 for storing the data relation information generated by the data relation information generating unit 4 in the data relation information storage unit 5a which is disposed separately from the map DB in the map DB storage unit 6a, the independency between the data relation information and the map data in the map DB is ensured, no influence is imposed on the map data even if data relation information is physically eliminated from the data relation information storage unit 5a. Therefore, unnecessary data relation information can be eliminated easily, and an improvement in the ease of maintenance of the data relation information database can be achieved

In addition, because the information processing device in accordance with this Embodiment 1 includes the data relation information output unit 5 for storing the data relation information generated by the data relation information generating unit 4 in the map DB in the map DB storage unit 6a, the information processing device can access to the data relation information and each map data (a background map, a name, etc.) by simply establishing a connection to the single map DB.

### Embodiment 2

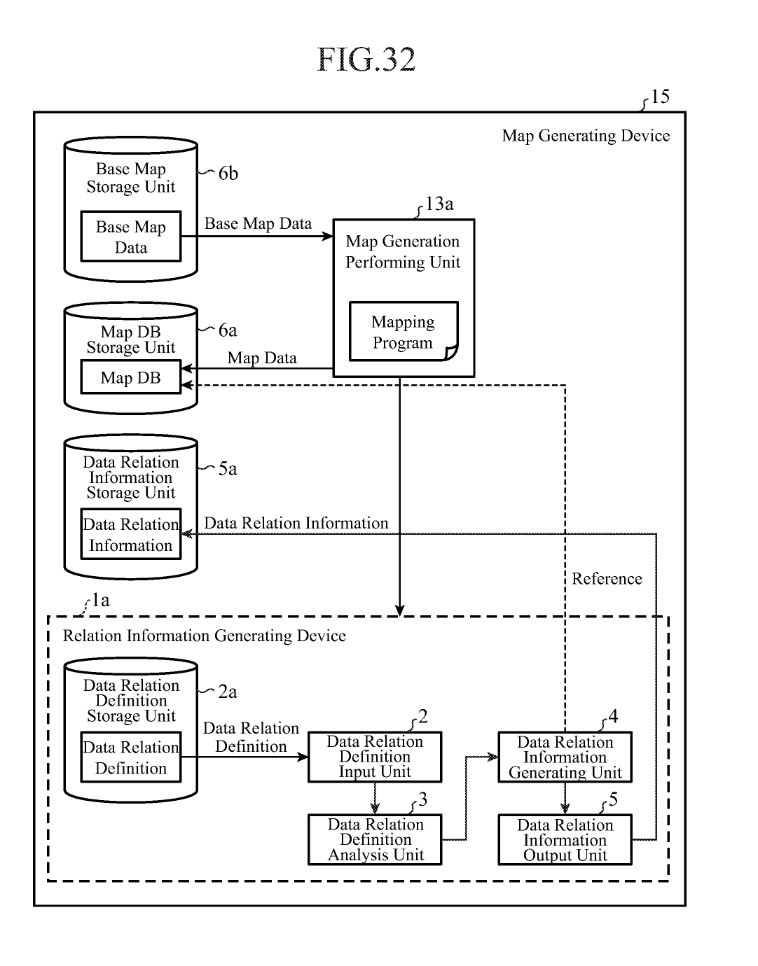

FIG. 32 is a block diagram showing the structure of a map generating device in accordance with Embodiment 2 of the present invention. The map generating device 15 in accordance with Embodiment 2 generates map data for use in navigation processing by using base map data, and is an information processing device having a hardware configuration shown in FIG. 2 explained in above-mentioned Embodiment 1. The map generating device has a relation information generating unit 1a, a data relation information storage unit 5a, a map DB storage unit 6a, a base map storage unit 6b, and a map generation performing unit 13a as its function configuration, as shown in FIG. 32. Further, the relation information generating unit 1a is a component for generating data relation information, like the relation information generating device 1 shown in above-mentioned Embodiment 1, and includes a data relation definition input unit 2, a data relation definition storage unit 2a, a data relation definition analysis unit 3, a data relation information generating unit 4, and a data relation information output unit 5.

The data relation definition input unit 2 is a component for inputting a data relation definition from the data relation definition storage unit 2a into the data relation definition analysis unit. For example, the data relation definition input unit searches through the data relation definition storage unit 2a for a data relation definition specified by a map generation performing unit 13a to acquire this data relation definition. Data relation definitions regarding a map DB stored in the map DB storage unit 6a are stored in the data relation definition storage unit 2a. The data relation definition analysis unit 3 is a component for analyzing a relation between data which is defined in the data relation definition acquired by the data relation definition input unit 2.

The data relation information generating unit 4 is a component for generating data relation information defining a relation between data which construct map data in the map DB on the basis of the results of the analysis of the data relation definition by the data relation definition analysis unit 3 in an output form defined in a data relation information output definition. Further, the data relation information output unit 5 is a component for storing the data relation information generated by the data relation information generating unit 4 in an output destination of a storing method defined in the data relation information output definition.

The data relation information storage unit 5a stores the data relation information generated by the data relation information generating unit 4. Data relation information defining a relation between data which construct map data in the map DB is stored in this data relation information storage unit 5a. Therefore, by incorporating the map generating device 15 in accordance with Embodiment 2 into a navigation device, the navigation device is enabled to efficiently acquire desired map data from the map DB at a high speed by simply carrying out a data access with reference to data relation information.

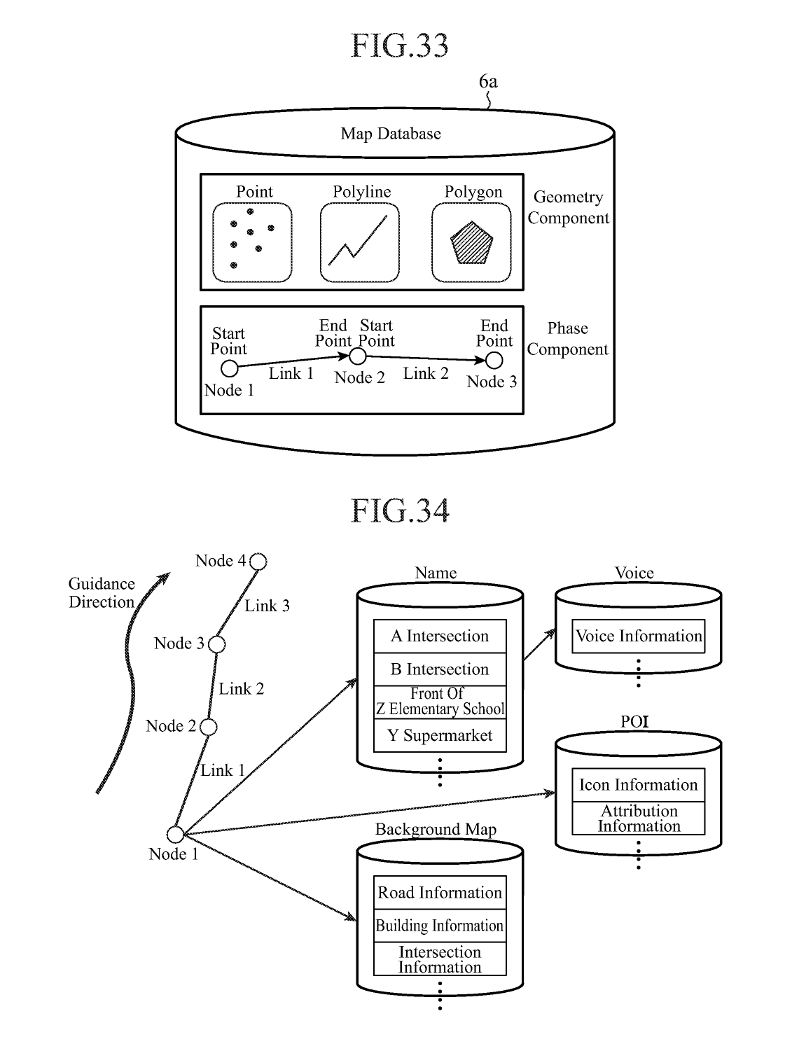

The map DB storage unit 6a stores the map DB which consists of map data for use in the navigation processing, such as a route search and a route guidance. The base map storage unit 6b stores data for use in the generation of map data in the map DB. The data stored in the base map storage unit 6b (referred to as the base map data from here on) are the source that constructs any map data stored in the map DB. For example, data about geometry components and data about phase components which will be mentioned below with reference to FIG. 33 are provided as the base map data.

The map generation performing unit 13a is a component for generating map data which are used for the navigation processing by establishing a relation between each of various functions of the navigation processing and base map data stored in the base map storage unit 6b. For example, a CPU 7 of an information processing device shown in FIG. 2 executes a map generating program to operate as the map generation performing unit 13a, and generates map data for use in route guidance, a map display, a route search, or the like.

Hereafter, the map DB stored in the map DB storage unit 6a will be explained. FIG. 33 is a diagram showing the structure of the map DB. As shown in FIG. 33, components showing graphic shapes (geometry components) and components showing networks each of which is a relation among data (phase components), which are provided as base elements, are registered as map data in the map DB while relations between the geometry components and the phase components are established. Each geometry component is map data which consists of a point showing a point, a polyline showing a line, and a polygon showing a surface. Further, each phase component is map data which consists of anode and a link. In addition to these components, each map data includes name data about road names and place names, voice data for use in a guiding voice at a time of providing route guidance, and POI (Point of Interest) data showing a distinctive location displayed by an icon or the like.

Next, the operation of the map generating device will be explained. Hereafter, a generating process of generating a map for use in route guidance which is a representative function of a navigation application when the map generating device 15 in accordance with Embodiment 2 is applied to a navigation device will be mentioned. FIG. 34 is a diagram for explaining an outline of the generation of a map for use in route guidance. In the route guidance, a node series (nodes 1 to 4) and a link series (links 1 to 3) as shown in FIG. 34 are acquired from the map DB as route information through a route search process, and an appropriate route is provided for the driver as the driver drives his or her vehicle. Information required for the route guidance includes names each showing a point via which the vehicle will travel, voices each saying a name which is to be uttered toward the driver, POIs each showing a distinctive location, a background map for visually displaying the point via which the vehicle will travel for the driver, and other information, such as a crossing image and traffic information. In the navigation processing, a map display and a route search are provided as functions, such as route guidance, in which plural pieces of information are used. A map display requires a background map, the names of points, POIs, etc., and a route search requires a road network, traffic information, etc.

The map generation performing unit 13a reads various map data, such as geometry components and phase components as shown in FIG. 33, road name data and point name data, voice data, and POI data, from the base map storage unit 6b as base map data for use in the generation of a map. Next, the map generation performing unit 13a generates map data to be registered in the map DB by establishing relations among the various map data including the geometry components, the phase components, the name data, the voice data, and the POI data using the base map data read from the base map storage unit 6b. The route guidance is carried out by using names, voices, maps, etc. corresponding to a road network (nodes and links) showing a route acquired after a route search is made. In addition, images of signs (direction boards) and branch points, etc. are used at the time of providing the route guidance. By carrying out a display process using such map data, the navigation device provides the route acquired as the result of the route search and displayed on the background map, and the guidance information (guiding voices and POIs) used for guiding the driver from the place of departure to the destination according to the route for the driver via a display unit 10 and a not-shown speaker, as shown in, for example, FIG. 34.

The various base map data which are related to each other in the above-mentioned way are stored in corresponding tables in the map DB, respectively, and a relation is defined for each of the tables. In an example shown in FIG. 34, a background map table, a name table, and a POI table are related to a node 1, and a voice table is related to the name table. The relations among these base map data are defined in data relation definitions.

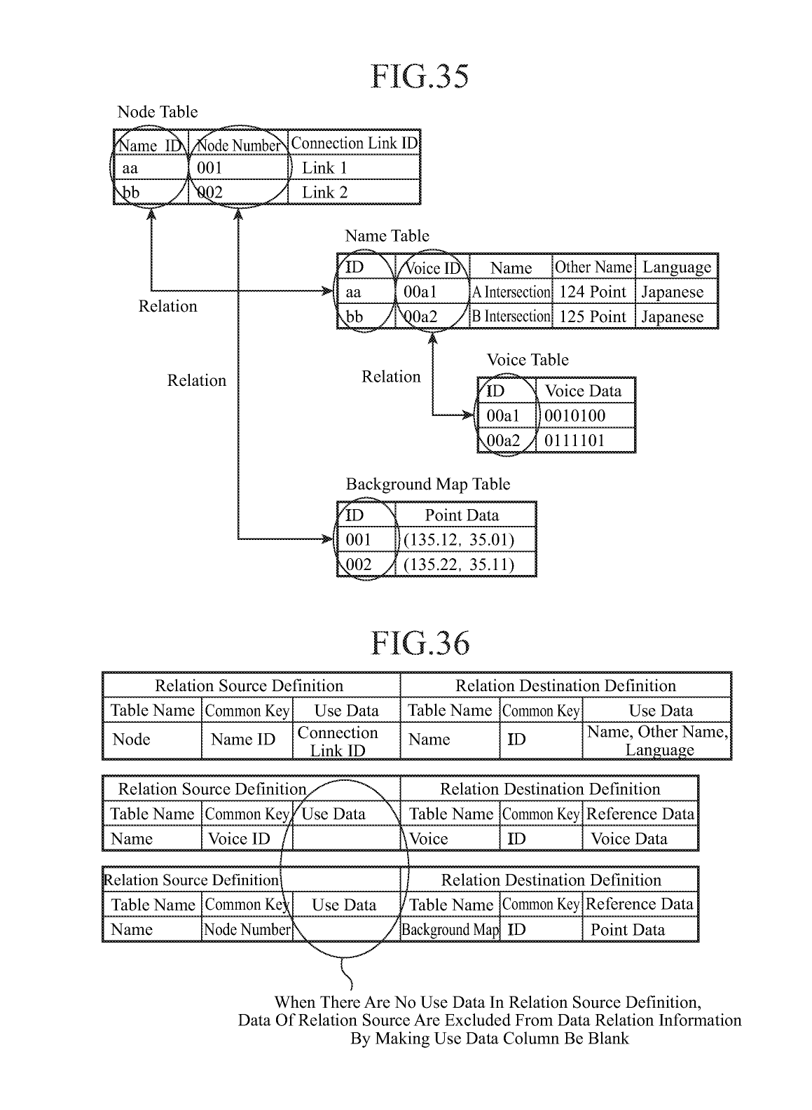

FIG. 35 is a diagram showing the relations among the various data shown in FIG. 34. In a node table shown in FIG. 35, node numbers of 001 and 002 and links 1 and 2 as connection link IDs are defined for the nodes 1 and 2 shown in FIG. 34, respectively. Further, in the node table, a name ID of “aa” and a name ID of “bb” are added to the node 1 and the node 2 as the IDs of the name data corresponding to the nodes 1 and 2, respectively. Data in the node table and data in the name table are related to each other via these name IDs being used as common keys. Similarly, in the background map table in which point data (latitude and longitude) about the nodes 1 and 2 are stored, the node numbers of 001 and 002 are added as the IDs of the point data about the nodes 1 and 2, respectively, and data in the node table and data in the background map table are related to each other via these IDs being used as common keys. In the voice table in which voice data are stored in a binary format, the voice data of a voice ID of “00a1” is related to a name of “A intersection” of the name table, and the voice data of a voice ID of “00a2” is related to a name of “B intersection” of the name table. These voice IDs of “00a1” and of “00a2” are common keys, and the name table and the voice table are related to each other via the common keys.

When the map generation performing unit 13a generates map data, the above-mentioned relations among the data are defined as data relation definitions as shown in FIG. 36, and are stored in the data relation definition storage unit 2a. FIG. 36 is shown under the assumption that a connection link ID attribute of the node table which is a relation source is also included in each data relation information, and the data format shown in FIG. 13 is used as that of each data relation information. Further, in the example shown in FIG. 36, the node table is related to the name table as the relation source, and the connection link ID of the node table is set as the use data of the relation source definition. On the other hand, although the name table is related to the voice table and the background map table as the relation source, there are no use data of the relation source. In this case, as shown in FIG. 36, it can be set up that the data of the relation source are excluded from the target to be included in data relation information by making the use data column of the relation source definition be blank.

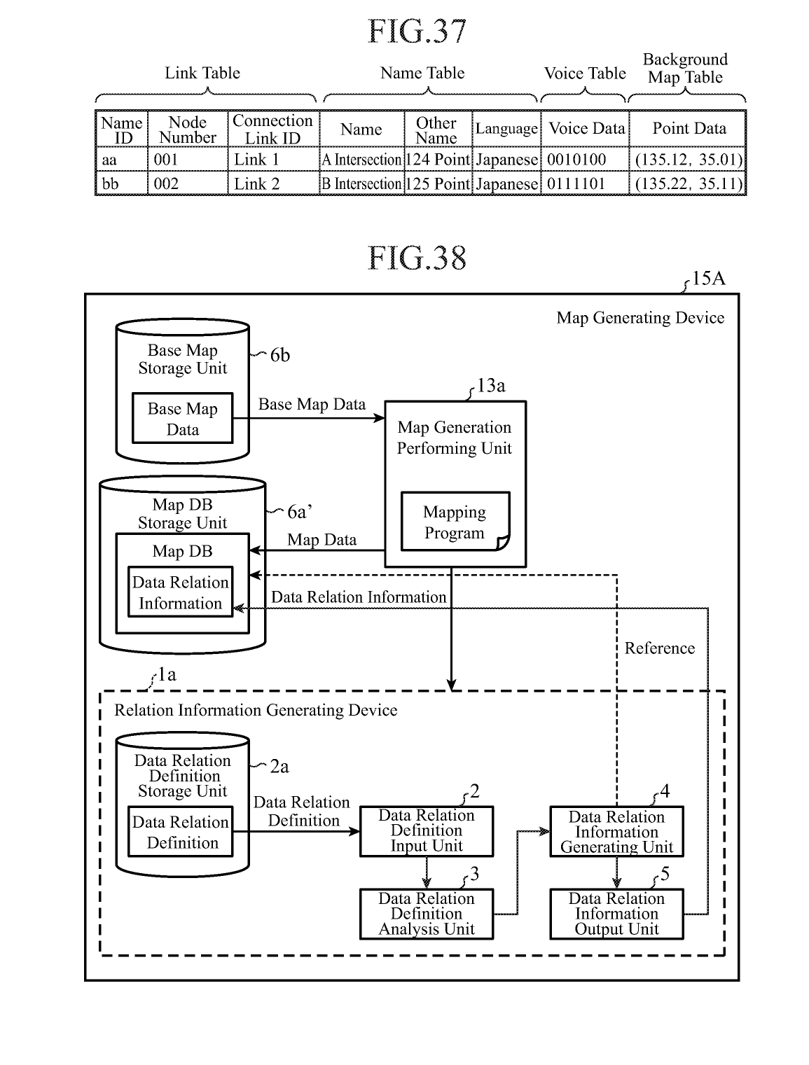

Further, the map generation performing unit 13a commands the relation information generating unit 1a to generate data relation information in which relations among the various data (base map data) which construct the above-mentioned map data are defined. In the relation information generating unit 1a, the data relation definition input unit 2 inputs a data relation definition regarding the map data specified by the map generating device 15 from the data relation definition storage unit 2a into the data relation definition analysis unit. Next, the data relation definition analysis unit 3 analyzes a relation between data which construct the map data which is defined in the data relation definition. Then, the data relation information generating unit 4 generates data relation information in an output form defined in a data relation information output definition on the basis of the relation between the data which the data relation definition analysis unit determines by analyzing the data relation definition. As a result, data relation information as shown in FIG. 37 is generated. In the example shown in FIG. 37, a case in which the actual data of the data, such as a name of “A intersection”, voice data of “0010100”, and point data of “(135.12, 35.01)” are stored is shown.

Next, the data relation information output unit 5 stores the data relation information generated by the data relation information generating unit 4 in the output destination of a storing method defined in the data relation information output definition. FIG. 38 is a diagram showing the structure of the map generating device in a case of storing the data relation information in the map DB. In the map generating device 15A shown in FIG. 38, the data relation information output unit 5 physically stores the data relation information in the map DB as a map DB storage unit 6a′. By doing in this way, the navigation device can access the data relation information and each data (background map data, name data, etc.) which constructs the map data only by establishing a connection to the single map DB.

As mentioned above, the map generating device in accordance with this Embodiment 2 includes the data relation definition input unit 2 for inputting a data relation definition defining a relation between data which construct map data in the map DB into the data relation definition analysis unit, the data relation definition analysis unit 3 for analyzing the relation between the data defined in the data relation definition inputted thereto by the data relation definition input unit 2, and the data relation information generating unit 4 for generating data relation information in which data related to each other which construct map data in the map DB are set on the basis of the results of the analysis of the data relation definition by the data relation definition analysis unit 3. Because the map generating device is thus constructed in such a way as to generate data relation information in which data related to each other which construct map data in the map DB are set as needed, the map generating device can efficiently acquire desired map data at a high speed from the map DB on the basis of the data relation information.

Further, because the data relation information stores actual data of data related to each other which construct map data in the map DB in the map generating device in accordance with this Embodiment 2, the map generating device can acquire the actual data from the data relation information without referring to tables in the map DB, such as an RDB, thereby being able to provide an improvement in the data access capability.

In addition, because the data relation information can store an index for identifying the actual data of the data related to each other which construct map data in the map DB in the map generating device in accordance with this Embodiment 2, it is not necessary to carry out redundant management of the actual data for both the data relation information and the map DB, and any increase in the data size can be prevented.

In addition, because the data relation information can store a storage location in the map DB of the actual data of the data related to each other which construct map data in the map DB in the map generating device in accordance with this Embodiment 2, it is not necessary to carry out redundant management of the actual data for both the data relation information and the map DB, like in the case in which the data relation information stores an index, and any increase in the data size can be prevented. Further, when variable length binary data are deserialized, the map generating device can access a desired attribute value at a high speed.

In addition, because the map generating device in accordance with this Embodiment 2 includes the data relation information output unit 5 for storing the data relation information generated by the data relation information generating unit 4 in the data relation information storage unit 5a which is disposed separately from the map DB in the map DB storage unit 6a′, the independency between the data relation information and the map data in the map DB is ensured, no influence is imposed on the map data even if data relation information is physically eliminated from the data relation information storage unit 5a. Therefore, unnecessary data relation information can be eliminated easily, and an improvement in the ease of maintenance of the data relation information database can be achieved.

In addition, because the map generating device in accordance with this Embodiment 2 includes the data relation information output unit 5 for storing the data relation information generated by the data relation information generating unit 4 in the map DB in the map DB storage unit 6a′, the map generating device can access to the data relation information and each map data (a background map, a name, etc.) by simply establishing a connection to the single map DB.

### Embodiment 3

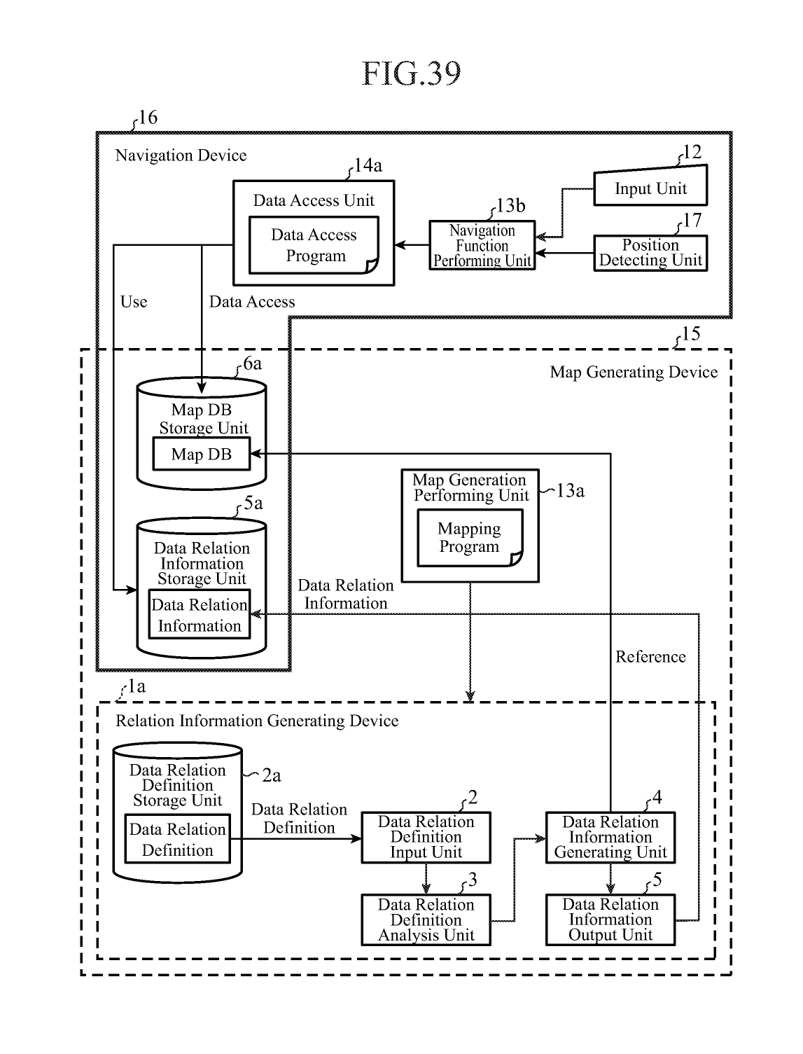

FIG. 39 is a block diagram showing the structure of a navigation device in accordance with Embodiment 3 of the present invention. The navigation device 16 in accordance with Embodiment 3 carries out navigation processing by using map data generated by the map generating device 15 in accordance with Embodiment 2. The navigation device 16 shares a data relation information storage unit 5a in which a map DB in which map data are stored and data relation information are stored with the map generating device 15. Because map data generated in advance by the map generating device 15 are used in the navigation device, a base map storage unit 6b is omitted in FIG. 39.

The navigation device 16 in accordance with Embodiment 3 is provided with an input unit 12, a navigation function performing unit 13b, a data access unit 14a, and a position detecting unit 17. The input unit 12 is the same as that explained with reference to FIG. 2. Further, the position detecting unit 17 corresponds to the communication unit 11 shown in FIG. 2 having a function of receiving GPS signals from GPS satellites or an FM radio signal to detect position information. The navigation function performing unit 13b is a component for carrying out various functions of the navigation processing on the basis of map data acquired from the map DB and the current position detected by the position detecting unit 17. The map data for use in the navigation function performing unit 13b are acquired from the map DB by the data access unit 14a.

The data access unit 14a is a component for carrying out a data access to the map DB with reference to data relation information corresponding to a function carried out by the navigation function performing unit 13b to acquire desired map data. For example, a CPU 7 of an information processing device shown in FIG. 2 operates as the data access unit 14a by executing a data access program. In FIG. 39, the same components as those shown in FIGS. 2 and 32 are designated by the same reference numerals, and the explanation of the components will be omitted hereafter.

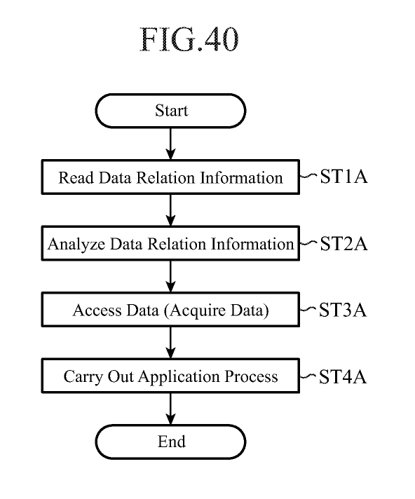

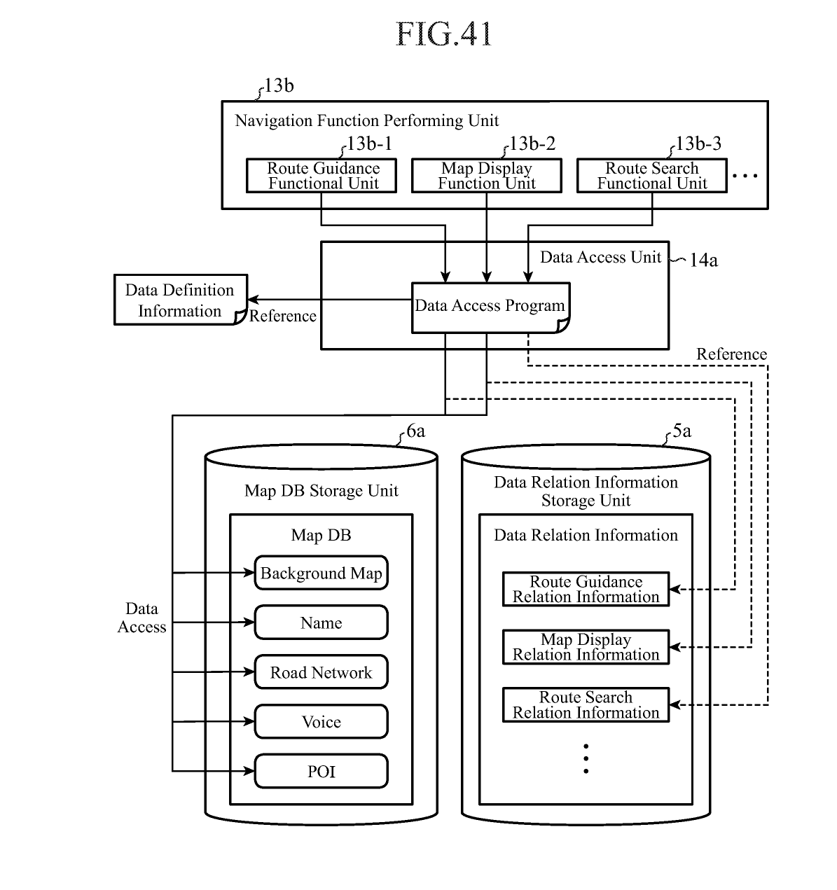

Next, the operation of the navigation device will be explained. FIG. 40 is a flow chart showing a flow of an application process carried out by the navigation device in accordance with Embodiment 3. The navigation function performing unit 13b starts the execution of a navigation application for implementing a predetermined function. When a need to acquire the map data for use in the above-mentioned predetermined function from the map DB occurs, the data access unit 14a reads the data relation information corresponding to the above-mentioned predetermined function from the data relation information storage unit 5a in response to a command from the navigation function performing unit 13b (step ST1A). Next, the data access unit 14a determines (analyzes) in which table in the map DB the data required to process the above-mentioned predetermined function exist as an attribute for the data relation information read in step ST1A (step ST2A). Next, the data access unit 14a accesses the desired data in the relation destination to acquire the actual data using a relation between data which construct the map data in the map DB for use in the above-mentioned predetermined function according to the results of the analysis of the data relation information (step ST3A). The navigation function performing unit 13b carries out the navigation application process by using the map data which the data access unit 14a has acquired in this way (step ST4A).

FIG. 41 is a diagram showing an outline of a usage pattern of the data relation information generated for each function implemented by the navigation application. Hereafter, a case in which the information processing device shown in FIG. 2 functions as the navigation device 16 will be described. The navigation device 16 has an application corresponding to each of the various functions in the navigation processing as the navigation application. For example, application programs for implementing a route guidance function, a map display function, and a route search function respectively are stored in an external storage unit 9 shown in FIG. 2.

Further, the data relation information for each function generated by the map generating device 15 is registered in the data relation information storage unit 5a disposed separately from the map DB. More specifically, as shown in FIG. 41, route guidance relation information which is data relation information corresponding to the route guidance function, map display relation information which is data relation information corresponding to the map display function, and route search relation information which is data relation information corresponding to the route search function are stored in the data relation information storage unit 5a. For example, when carrying out the application regarding the route guidance function, the CPU 7 of the information processing device shown in FIG. 2 operates as a route guidance functional unit 13b-1 for carrying out a process corresponding to the route guidance function in the navigation function performing unit 13b. Similarly, when carrying out the application regarding the map display function, the CPU 7 operates as a map display function unit 13b-2 for processing the map display function in the navigation function performing unit 13b, and when carryings out the application regarding the route search function, the CPU 7 operates as a route search functional unit 13b-3 for carrying out a process corresponding to the route search function in the navigation function performing unit 13b.

Further, for example, when a need to acquire map data used to process the route guidance function from the map DB in the map DB storage unit 6a occurs, the CPU 7 executes the data access program and operates as the data access unit 14a. At this time, the data access unit 14a analyzes the route guidance relation information corresponding to the route guidance function on the basis of data definition information in which the configuration of the data relation information is defined. At this time, the data access unit analyzes in which one of the various tables (a background map table, a name table, a road network table, a voice table, and a POI table which are shown in FIG. 41, etc.) in the map DB the data which constructs the map data required for the route guidance exist as an attribute. The data access unit 14a refers to the results of this analysis to carry out a data access to the map DB in the map DB storage unit 6a by using a relation between data which construct the map data for use in the route guidance function to acquire the actual data of the data which construct the desired map data.

Thus, in the example shown in FIG. 41, the data relation information is stored in the data relation information storage unit 5a, and is managed separately from the map data in the map DB regarding access to the data relation information. In this case, because the data relation information is disposed independently from the map DB, the databases are physically separate from each other. Because the databases are constructed in this way, when unnecessary data relation information occurs, no influence is imposed on the map data even if the unnecessary data relation information is eliminated physically from the data relation information storage unit 5a. Therefore, any unnecessary data relation information can be eliminated easily, and an improvement in the ease of maintenance of the data relation information database can be achieved. However, the two databases including the map DB and the data relation information database are disposed and two connections for data access are required in this embodiment.

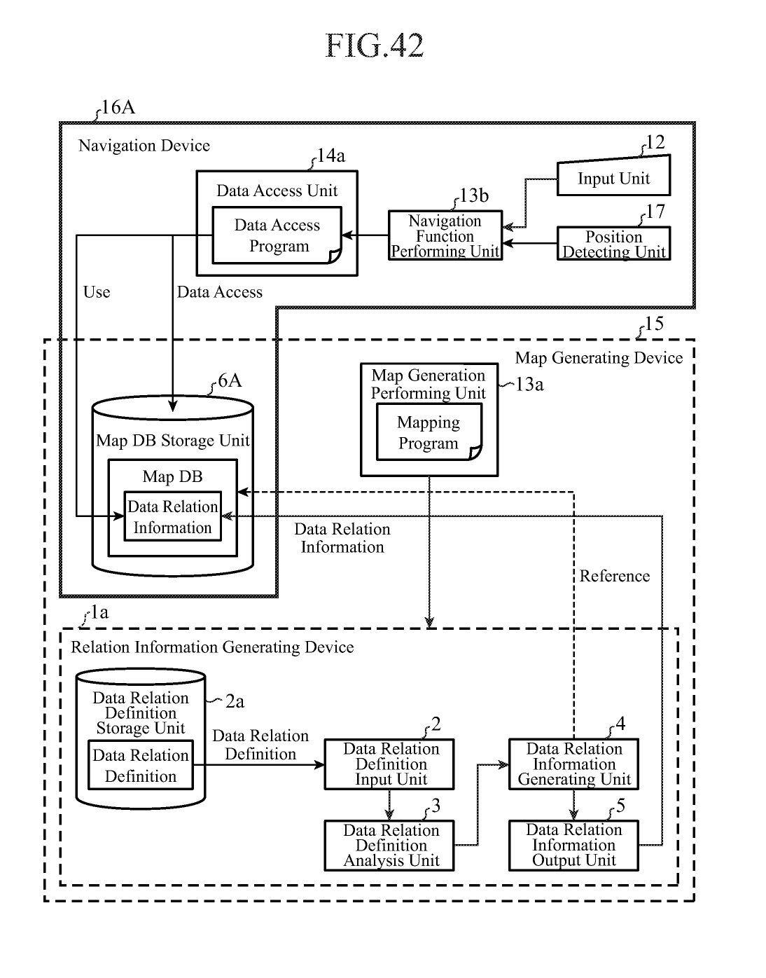

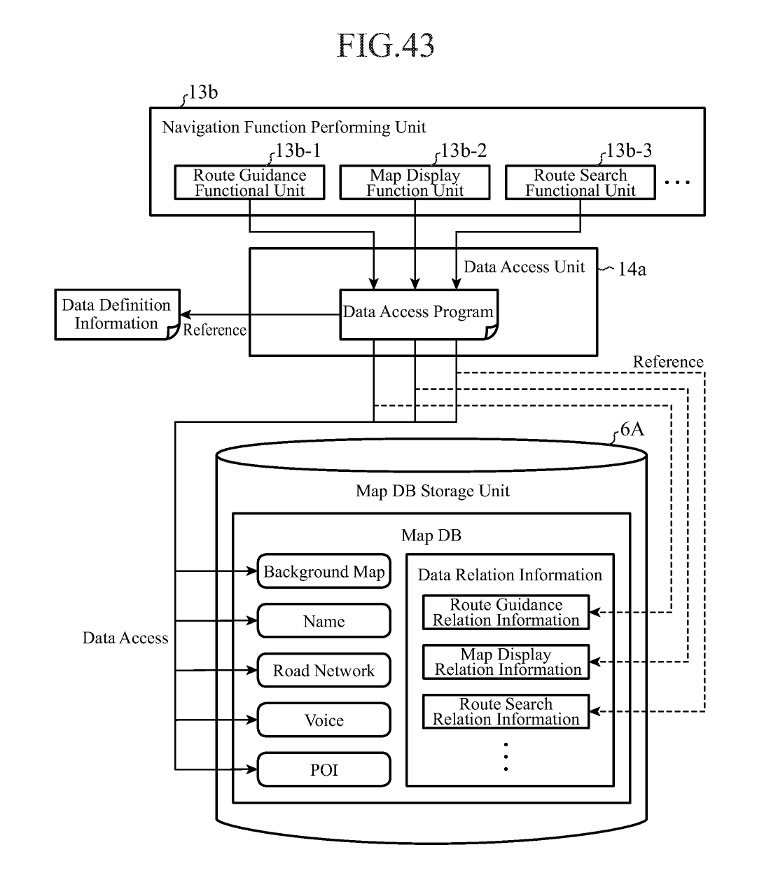

FIG. 42 is a block diagram showing another example of the structure of the navigation device in accordance with Embodiment 3, and shows a structure in a case of storing the data relation information in the map DB. In the navigation device 16A shown in FIG. 42, the data relation information output unit 5 of the map generating device 15 stores the data relation information in the map DB physically. FIG. 43 is a diagram showing an outline of another example of the usage pattern of the data relation information generated for each function implemented by the navigation application, and shows an example of using the map DB including the data relation information as shown in FIG. 42 as a part of the navigation device. As shown in FIG. 43, by physically storing the data relation information in the map DB in the map DB storage unit 6A, the data access unit 14a can access to the data relation information and each map data (a background map, a name, etc.) only by establishing a connection to the single map DB. More specifically, because only one connection for data access to the map DB storage unit 6A is needed, a higher-speed data access can be carried out as compared with the case of using the usage pattern shown in FIG. 41.

As mentioned above, the navigation device in accordance with this Embodiment 3 includes: the data relation information storage unit 5a or the map DB storage unit 6A for storing data relation information in which data related to each other, which construct map data in the map DB generated by the external map generating device 15 on the basis of a data relation definition defining a relation between data which construct map data in the map DB, are defined; the navigation function performing unit 13b for carrying out navigation processing; and the data access unit 14a for referring to the data relation information stored in the data relation information storage unit 5a or the map DB storage unit 6A to acquire the map data for use in the navigation function performing unit 13b in the navigation processing from the map DB. Because the navigation device is constructed in this way, the navigation device can efficiently acquire desired map data from the map DB at a high speed by referring to the data relation information in which the data related to each other which construct the map data in the map DB are set, and can carry out the navigation processing.

Further, because the data relation information storage unit 5a or the map DB storage unit 6A stores the data relation information for each function carried out as the navigation processing by the navigation function performing unit 13b in the navigation device in accordance with this Embodiment 3, the navigation device can efficiently acquire the data for use in each function at a high speed from the map DB.

In addition, because the navigation device in accordance with this Embodiment 3 includes the data relation information output unit 5 for storing the data relation information generated by the data relation information generating unit 4 in the data relation information storage unit 5a which is a data set disposed separately from the map DB, the independency between the data relation information and the map data in the map DB is ensured, no influence is imposed on the map data even if data relation information is physically eliminated from the data relation information storage unit 5a. Therefore, unnecessary data relation information can be eliminated easily, and an improvement in the ease of maintenance of the data relation information database can be achieved.

In addition, because the navigation device in accordance with this Embodiment 3 includes the data relation information output unit 5 for storing the data relation information generated by the data relation information generating unit 4 in the map DB, the navigation device simply establishes only one connection for data access to the map DB storage unit 6A to acquire the data relation information, a higher-speed data access can be carried out as compared with the case of the usage pattern of storing the data relation information in the data relation information storage unit 5a.

### Embodiment 4

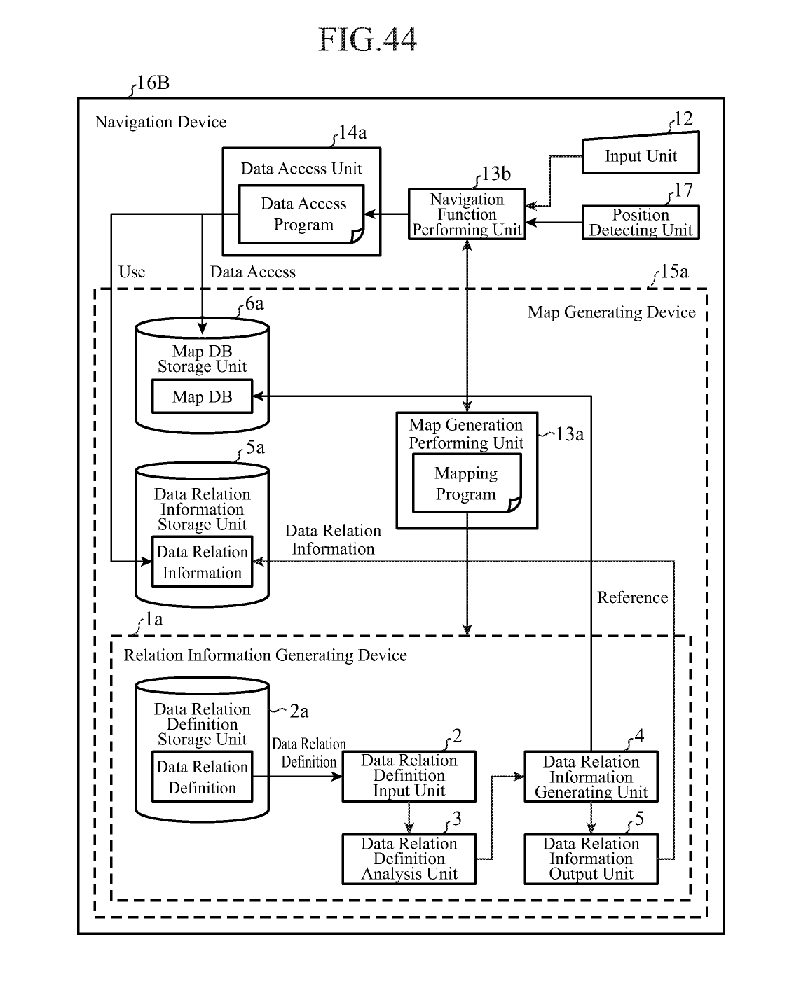

FIG. 44 is a block diagram showing the structure of a navigation device in accordance with Embodiment 4 of the present invention. In FIG. 44, the navigation device 16B in accordance with Embodiment 4 is provided with a map generating unit 15a that operates like the map generating device shown in Embodiment 2, and carries out navigation processing by using map data generated by the map generating unit 15a. Further, the map data are stored in a map DB in a map DB storage unit 6a, and data relation information generated by the map generating unit 15a is stored in a data relation information storage unit 5a. A base map storage unit 6b is omitted in FIG. 44. The same components as those shown in FIGS. 2, 32, and 39 are designated by the same reference numerals, and the explanation of the components will be omitted hereafter.

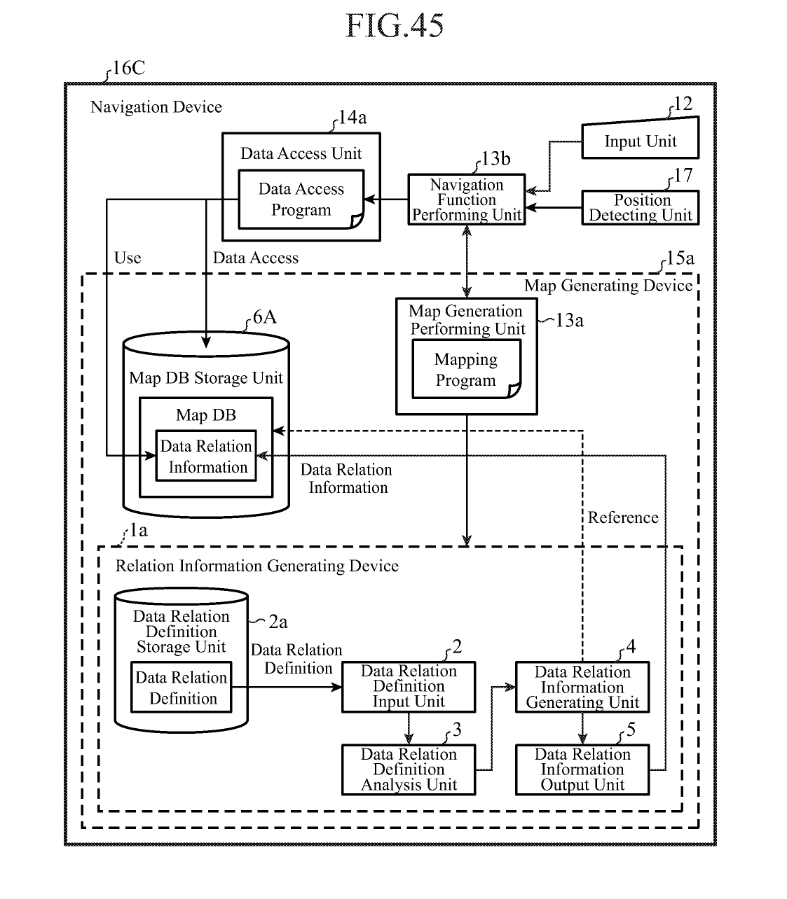

FIG. 45 is a block diagram showing another example of the structure of the navigation device in accordance with Embodiment 4, and shows a case in which data relation information is stored in the map DB. As shown in FIG. 45, the navigation device 16C includes a map generating unit 15a, like that shown in FIG. 44, and data relation information is stored in the map DB in the map DB storage unit 6A. Because a data access unit 14a can simply establish only one connection for data access to the map DB storage unit 6A to acquire data relation information, the data access unit can carry out data access at a high speed as compared with the structure shown in FIG. 44. In FIG. 45, the same components as those shown in FIGS. 2, 32, and 42 are designated by the same reference numerals, and the explanation of the components will be omitted hereafter.

As shown in FIGS. 44 and. 45, because each of the navigation devices 16B and 16C in accordance with Embodiment 4 is provided with the map generating unit 15a for generating data relation information from a data relation definition regarding the map DB, each of the navigation devices can generate data relation information properly. Further, because each of the navigation devices can generate data relation information properly according to predetermined generation conditions, no temporal cost to generate data relation information in advance is needed, and the cost of data size, such as an HDD, for storing pieces of data relation information according to various functions can be reduced.

“Road type”, “predetermined scale”, “area”, “position”, etc. are provided as the conditions for generating data relation information on-line. For example, the “predetermined scale” includes a generation condition of giving a high priority to a default display scale. Under this generation condition, map data with the default display scale related to each other are set into data relation information. Further, the “area” includes a condition of giving a higher priority to a specified location in a country, a state, or a city, ward, town, or village. Under this generation condition, for example, map data about a specified location and related to each other are set into data relation information. The “Position” includes a condition of giving a higher priority to ITS (Intelligent Transport Systems) spot (a driving safety support spot is assumed to be a high priority point), an area surrounding the vehicle position, points set as conditions for route search (a destination, a place of departure, a waypoint, etc.), or a location specified in advance. Under this generation condition, for example, map data about an ITS spot and its surrounding area and related to each other are set into data relation information. A location where traffic information is sent from a roadside transmitter disposed along a road is called an ITS spot, and a navigation device which complies with the ITS can display traffic information received thereby on a navigation screen. The “road type” is a condition of generating data relation information from map data by giving a higher priority to map data about a layer having a higher-order road type, i.e., map data about roads having a higher degree of importance (a national road and a highway), and map data about an area surrounding the roads.

In contrast, when no generation conditions of generating data relation information are specified, in a route guidance function or a route search function using road information mainly, which is a main function of the navigation device, pieces of data relation information are generated sequentially for road data in order starting from road data about predetermined road types included in the route. For example, because a specific road, such as a highway or national road, whose road type is in a high layer extends over some areas, there is a possibility that various map data about the specific road (a background map, names, voices, POIs) are related to one another. Therefore, the navigation device generates data relation information for road data in order starting from road data about highways and national roads having a high degree of importance. In addition, when no generation conditions of generating data relation information are specified, in a map display function of the navigation device, data relation information is generated from map data about an area surrounding the vehicle position. A predetermined condition can be set as a generation condition of generating data relation information according to the navigation specifications, and data relation information can be generated automatically under this predetermined condition.

In addition, after carrying out the navigation processing, the navigation device can automatically delete the data relation information used (referred to) in the process from the data relation information storage unit 5a or the map DB storage unit 6A. By thus eliminating the data relation information which has been used in the process and has become unnecessary from the storage unit, the navigation device can prevent an increase in the used capacity of the storage unit.

In addition, for example, a navigation function performing unit 13b can be constructed in such a way as to store a history of travels in each of which the vehicle travelled along a road in the past in the external storage unit 9, and the map generating unit 15a can be constructed in such a way as to generate data relation information about each road along which the vehicle travelled in the past and which is specified by the navigation function performing unit 13b. By doing in this way, when the vehicle travels along this road again, the navigation device can carry out the navigation processing while efficiently acquiring desired data from the map DB at a high speed by referring to the data relation information.

Next, the operation of the navigation device will be explained.

(1) Generation of Data Relation Information about an Area Surrounding the Current Position

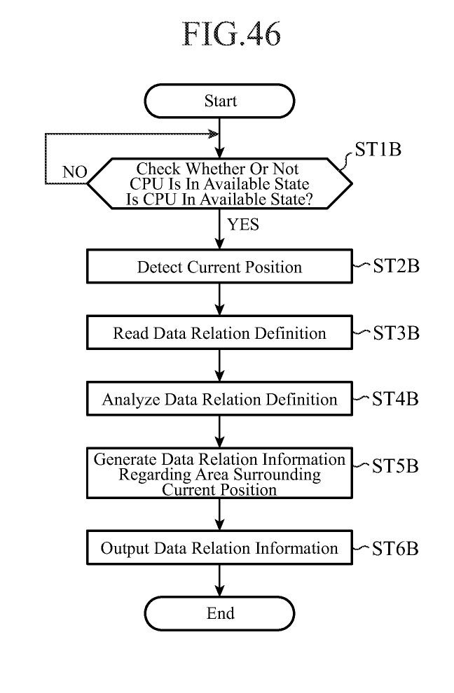

FIG. 46 is a flow chart showing an example of the generating process of generating data relation information about an area surrounding the current position. First, a map generation performing unit 13a monitors a CPU usage (e.g., a use rate per a predetermined time of the CPU), and determines whether or not the CPU 7 is in an available state with a small CPU processing load (step ST1B). For example, the map generation performing unit compares the CPU usage monitored thereby with a threshold for defining a predetermined CPU usage range within which the generation of data relation information is allowed, and determines whether or not to generate data relation information according to the results of the comparison.

When determining that the CPU is not in the available state in which the CPU should generate data relation information (when NO in step ST1B), the map generation performing unit 13a continues to monitor the CPU usage and repeats the process of step ST1B. In contrast, when determining that the CPU is in the available state in which the CPU should generate data relation information (when YES in step ST1B), the map generation performing unit 13a commands the navigation function performing unit 13b to cause a position detecting unit 17 to detect the current position of the vehicle (step ST2B). The current position of the vehicle detected by the position detecting unit 17 is outputted from the map generation performing unit 13a to a relation information generating unit 1a.

A data relation definition input unit 2 of the relation information generating unit 1a reads the data relation definition of the map data corresponding to the current position of the vehicle inputted thereto from the map generation performing unit 13a from a data relation definition storage unit 2a (step ST3B). Next, a data relation definition analysis unit 3 analyzes a relation between data defined in the data relation definition acquired by the data relation definition input unit 2 (step ST4B)

A data relation information generating unit 4 then generates data relation information about an area surrounding the current position of the vehicle in an output form defined in a data relation information output definition on the basis of the results of the analysis of the data relation definition by the data relation definition analysis unit 3 (step ST5B). The map data in the navigation device are managed on a per region basis, all of the map area in the map DB being divided into a plurality of regions (referred to as meshes or tiles). In this case, data relation information about a divided region to which the current position of the vehicle belongs is generated. For example, the data relation information generating unit acquires the relation source data about meshes in order starting from a mesh including the current position of the vehicle, and also acquires the relation destination data corresponding to the relation source data from the map DB to generate data relation information. In addition, the data relation information generating unit similarly acquires the relation source data and the relation destination data about meshes including an area surrounding the current position, and generates data relation information.

Next, the data relation information output unit 5 stores the data relation information generated by the data relation information generating unit 4 in the output destination of a storing method defined in the data relation information output definition (step ST6B).

(2) Generation of Data Relation Information about the User's Own Country

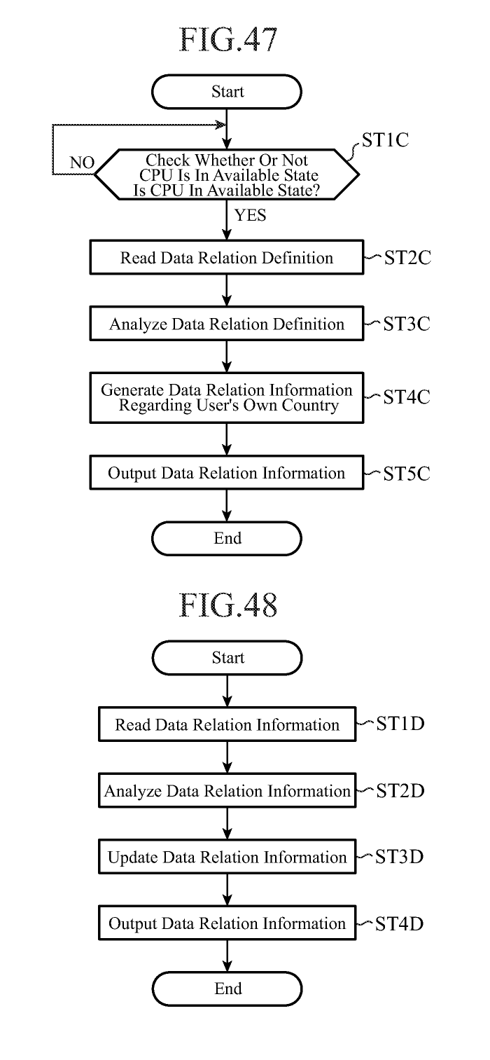

Navigation devices used in Europe and so on can have map DBs for use in two or more countries in which users are enabled to travel other than their own countries. In such a case, the navigation device in accordance with Embodiment 4 has data relation definitions regarding map DBs provided for plural countries, and generates data relation information from the data relation information corresponding to the country in which the vehicle is located. FIG. 47 is a flow chart showing an example of the generating process of generating data relation information about the user's own country. First, the map generation performing unit 13a monitors a CPU usage (e.g., a use rate per a predetermined time of the CPU), and determines whether or not the CPU 7 is in an available state with a small CPU processing load (step ST1C). The details of this determination are the same as that shown in FIG. 46.

When determining that the CPU is not in the available state in which the CPU should generate data relation information (when NO in step ST1C), the map generation performing unit 13a continues to monitor the CPU usage and repeats the process of step ST1C. In contrast, when determining that the CPU is in the available state in which the CPU should generate data relation information (when YES in step ST1B), the map generation performing unit 13a commands the navigation function performing unit 13b to acquire information showing the country in which the vehicle is travelling currently and notify this information to the relation information generating unit 1a. The data relation definition input unit 2 of the relation information generating unit 1a reads a data relation definition corresponding to the country notified thereto from the map generation performing unit 13a from the data relation definition storage unit 2a (step ST2C). Hereinafter, a case in which the vehicle is located in the user's own country will be explained as an example. Next, the data relation definition analysis unit 3 analyzes a relation between data defined in the data relation definition acquired by the data relation definition input unit 2 (step ST3C).

The data relation information generating unit 4 then generates data relation information about the user's own country in an output form defined in a data relation information output definition on the basis of the results of the analysis of the data relation definition by the data relation definition analysis unit 3 (step ST4C). At this time, for example, the data relation information generating unit acquires the relation source data about meshes in order starting from the mesh including the current position of the vehicle, acquires the relation destination data corresponding to this relation source data from the map DB to generate data relation information, and similarly acquires the relation source data and the relation destination data about meshes including an area surrounding the current position to generate data relation information. Next, the data relation information output unit 5 stores the data relation information generated by the data relation information generating unit 4 in the output destination of a storing method defined in the data relation information output definition (step ST5C).

### (3) Process of Updating Data Relation Information

An update of data relation information is automatically carried out at the time that, for example, map data in the map DB which is source data is updated, that is, when triggered by an update of map data. FIG. 48 is a flow chart showing a process of updating data relation information. When the contents of the map DB are updated, the map generation performing unit 13a notifies an updated part of the map DB to the relation information generating unit 1a. The data relation definition input unit 2 of the relation information generating unit 1a reads a data relation definition corresponding to the updated part notified thereto from the map generation performing unit 13a from the data relation definition storage unit 2a (step ST1D). Next, the data relation definition analysis unit 3 analyzes a relation between map data defined in the data relation definition acquired by the data relation definition input unit 2 (step ST2D).

The data relation information generating unit 4 then updates the data relation information according to the update of the map DB in an output form defined in a data relation information output definition on the basis of the results of the analysis of the data relation definition by the data relation definition analysis unit 3 (step ST3D). For example, when predetermined POI data is updated, the data relation information generating unit carries out a process of replacing the POI data in the data relation information with the updated data. Next, the data relation information output unit 5 stores the data relation information generated by the data relation information generating unit 4 in the output destination of a storing method defined in the data relation information output definition (step ST4D). By thus providing a data relation definition in an external database disposed separately from the map DB, and managing the map data and the data relation information independently, the navigation device can update the data relation information with flexibility. For example, the navigation device can update data relation information in such a way that only a part updated in the map DB is reflected in the data relation information.

(4) Process of Generating New Data Relation Information according to an update of a data relation definition

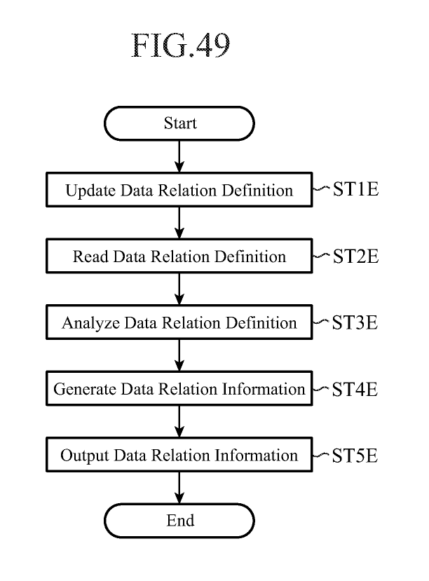

When a function of the navigation device is changed according to, for example, a change made to an application carried out by the navigation device, the data for use in an application process for implementing the changed function are also changed. In this case, a data relation definition itself of the database used in the application process is updated. FIG. 49 is a flow chart showing a process of generating data relation information according to an update of a data relation definition. When a new function is added to the navigation device, the navigation device updates a data relation definition according to the new function (step ST1E). In this case, a relation between data about the newly added function is defined in the data relation definition expressed in a tabular form or an XML form. An update of a data relation definition is carried out by the implementer of the data relation information. In the case of the navigation device, the navigation supplier which provides the maps for navigation carries out an update of a data relation definition.

The data relation definition input unit 2 of the relation information generating unit 1a reads the updated data relation definition from the data relation definition storage unit 2a (step ST2E). Next, the data relation definition analysis unit 3 analyzes a relation between map data defined in the data relation definition acquired by the data relation definition input unit 2 (step ST3E). The data relation information generating unit 4 then updates the data relation information in an output form defined in a data relation information output definition on the basis of the results of the analysis of the data relation definition by the data relation definition analysis unit 3 (step ST4E). Next, the data relation information output unit 5 stores the data relation information generated by the data relation information generating unit 4 in the output destination of a storing method defined in the data relation information output definition (step ST5E).

As mentioned above, the navigation device in accordance with this Embodiment 4 includes the data relation definition input unit 2 for inputting a data relation definition defining a relation between data which construct map data in the map DB into the data relation definition analysis unit, the data relation definition analysis unit 3 for analyzing the relation between the data defined in the data relation definition inputted thereto by the data relation definition input unit 2, the data relation information generating unit 4 for generating data relation information in which data related to each other which construct the map data in the map DB are set on the basis of the results of the analysis of the data relation definition by the data relation definition analysis unit 3, the navigation function performing unit 13b for carrying out the navigation processing, and the data access unit 14a for referring to the data relation information of map data for use in the navigation function performing unit 13b when performing the navigation processing to acquire the map data from the map DB. Because the navigation device constructed in this way can generate data relation information in which data related to each other which construct map data in the map DB are set as needed, the navigation device can efficiently acquire map data at a high speed from the map DB on the basis of the data relation information to carry out the navigation processing.

Further, because the data relation information generating unit 4 in accordance with this Embodiment 4 generates data relation information when the CPU usage falls within a predetermined range within which the data relation information generating unit should generate data relation information, the data relation information generating unit can generate data relation information without affecting the navigation processing and so on.

In addition, because the data relation information generating unit 4 in accordance with this Embodiment 4 generates data relation information of map data determined by at least one of a road type, an area, a map scale, and a position which are specified in advance, the data relation information generating unit can generate data relation information about desired data according to the specified conditions.

Further, because the data relation information generating unit 4 in accordance with this Embodiment 4 generates data relation information of map data about a predetermined road type as data relation information for use in route guidance or a route search in the navigation processing, and generates data relation information of map data about an area surrounding the current position as data relation information for use in a map display in the navigation processing, the data relation information generating unit can generate data relation information according to each function of the navigation processing which the navigation function performing unit 13b carries out.

In addition, because the navigation function performing unit 13b in accordance with this Embodiment 4 generates a history of travels in each of which a moving object equipped with or carrying the navigation device 16B or 16C travelled along a road in the past, and the data relation information generating unit 4 in accordance with this Embodiment 4 generates data relation information of map data about the roads along which the moving object travelled in the past, the navigation device can carry out the navigation processing while efficiently acquiring desired data from the map DB at a high speed by referring to data relation information when the vehicle travels along one of the roads again.

Further, because the data relation information generating unit 4 in accordance with this Embodiment 4 deletes the data relation information which has been used in the navigation processing when the navigation processing is completed, any increase in the used capacity of the storage unit for storing data relation information can be prevented.

In addition, because when map data stored in the map DB are changed, the data relation information generating unit 4 in accordance with this Embodiment 4 updates the data relation information of the map data according to the change, the update of the map data can be reflected automatically in the data relation information.

Further, although the case in which the present invention is applied to a car navigation device is shown in above-mentioned Embodiments 3 and 4, the present invention can be applied to not only a vehicle-mounted navigation device but also a navigation device for use in a mobile phone terminal or a mobile information terminal (PDA; Personal Digital Assistance). Further, the present invention can be applied to a PND (Portable Navigation Device) or the like which a person uses by carrying it onto a moving object, such as a vehicle, a train, a ship, or an airplane.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

### INDUSTRIAL APPLICABILITY

Because the navigation device in accordance with the present invention can efficiently acquire desired map data from a map database at a high speed on the basis of data relation information in which a relation between map data is defined, the navigation device is suitable for use as a navigation device that acquires a plurality of map data related to each other from the map database to carry out navigation processing.

### EXPLANATIONS OF REFERENCE NUMERALS

1 and 1A relation information generating device, 1a relation information generating unit, 2 data relation definition input unit, 2a data relation definition storage unit, 3 data relation definition analysis unit, 4 data relation information generating unit, 5 data relation information output unit, 5a data relation information storage unit, 6 and 6′ data set storage unit, 6a, 6a′, and 6A map DB storage unit, 6b base map storage unit, 7 CPU, 8 memory, 9 external storage unit, 10 display unit, 11 communication unit, 12 input unit, 13 function performing unit, 13a map generation performing unit, 13b navigation function performing unit, 13b-1 route guidance functional unit, 13b-2 map display function unit, 13b-3 route search functional unit, 14 and 14a data access unit, 15 and 15A map generating device, 16, and 16A to 16C navigation device, 17 position detecting unit.

1. A navigation device that carries out navigation processing by using data which the navigation device acquires from a data set, said navigation device comprising:
a navigation function performing unit for performing said navigation processing;
a storage unit for storing data relation information in which data related each other in said data set is defined for each function carried out by said navigation function performing unit as said navigation processing, the data relation information being generated by an external device on a basis of a data relation definition defining a relation between data in said data set; and
a data access unit for referring to said data relation information stored in said storage unit to acquire data for use in said navigation function performing unit when performing said navigation processing from said data set.

2. (canceled)

3. The navigation device according to claim 1, wherein said navigation device includes an output unit for referring to the data relation information generated by said external device to store said data relation information in another data set disposed separately from said data set from which said data related to each other are acquired.

4. The navigation device according to claim 1, wherein said navigation device includes an output unit for referring to the data relation information generated by said external device to store said data relation information in said data set from which said data related to each other are acquired.
